(19) United States
(12) Patent Application Publication
(10) Pub. No.: US 2019/0257138 A1
(43) Pub. Date: Aug. 22, 2019

(54) Garage Door Window

(71) Applicant: James A. Vitello, Escondido, CA (US)

(72) Inventor: James A. Vitello, Escondido, CA (US)

(21) Appl. No.: 16/274,001

(22) Filed: Feb. 12, 2019

Related U.S. Application Data
(60) Provisional application No. 62/631,687, filed on Feb. 17, 2018.

(51) Int. Cl. E06B 3/50; E06B 3/54; E05B 65/08; E05D 15/06; E06B 9/54

(52) U.S. Cl. CPC E06B 3/5081; E06B 3/54; E05B 65/08; E06B 7/32; E06B 9/54; E05Y 2900/106; E06B 2009/543; E05D 15/0621

(57) ABSTRACT

This invention is directed toward a window for a garage door panel, where the window has an opening that is surrounded by a body portion, and can be manufactured as part of the manufacture of a garage door panel, or retrofitted into an existing garage door panel. The window has a sliding door that can be slid open to allow for air ventilation, and has bars so that pets cannot escape through the window when it is open, and some combination of a sliding screen and optional security bars to keep insects out and keep pets in the garage. The optional security bars can be bolted or otherwise attached to the panel, thereby not only strengthening the panel but also making it harder for pets to escape and any burglars to enter.

### CROSS REFERENCE TO RELATED APPLICATIONS

This application claims priority to U.S. Provisional No. 62/631,687, filed 17 Feb. 2018, the contents of which are incorporated by reference into this application.

### STATEMENT REGARDING FEDERALLY SPONSORED RESEARCH OR DEVELOPMENT

This invention was not federally sponsored.

### BACKGROUND OF THE INVENTION

Field of the invention: This invention relates to the general field of garage doors, and more specifically to a window designed for a panel of a garage door.

History of the invention. Garage doors have been in existence for since Roman times, but as pertaining to the automobile industry began in the early 1900's, beginning as monolithic, single panel garage doors. Over the past several decades, sectional garage doors have become more and more popular as they can be “rolled” up in sections, thereby not requiring any “swing distance” away from the garage to swing as they are pulled up. A second advantage of sectional, or panel, garage doors is that each section or panel has a connection to track upon which it slides, thereby giving the door a more secure means of attachment to the garage door than would a traditional, monolithic garage door, which is usually connected to the garage door through two springs.

An ongoing problem with garage doors is that the common materials from which they are made—namely metal, plastic and wood—do not tend to “breath” well. Garages are notorious for storing a wide variety of smelly and toxic articles, ranging from the gasoline-powered engines of automobiles and lawnmowers to paint and other chemicals. While some monolithic garage doors had glass windows built into them that could be opened, the same technology has not made its way in a significant manner to the panel construction industry.

In addition to using their garages to store automobiles, yard equipment and the like, many homeowners use their garages as a temporary home for pets. Since the pets often have to share the garage with the aforementioned smelly and toxic items, it would be advantageous to improve the air circulation in a garage. While it would be relatively easy to build in some opening windows into a monolithic garage door, it is more difficult trying to fit an efficient “vent” into a single panel.

Even if a venting panel were to be successfully integrated into a panel, no pet owner would want his or her pet to escape from the garage through the vent—hence, there would need to be means of allowing air, but not the pet, to escape the garage. Thus, has been created a long-felt need for a window that can be installed—either during the construction or as a retrofit—into a panel that allows for both air ventilation and pet confinement.

The current invention provides just such a solution by having a window for a garage door panel with a slidable cover section. The window can be slid open to allow for air ventilation, and has bars so that pets cannot escape through the window when it is open. The second version of the invention has no pet door but is rather a ventilation window. It is contemplated that the Pet Door version of the invention would be installed on the lower panels, and the Ventilation Window version could be installed in upper and or lower panels, perhaps with the Pet Door or without.

### OBJECTS OF THE INVENTION

It is therefore an object of the present invention to provide a window that can be built into a garage door.

An additional object of the invention includes providing a window that can be installed into an existing garage door.

Another object of the invention is to provide a sliding mechanism by which the garage door window can be opened and closed easily.

A further object of the invention is to provide bars on the window to prevent pets from escaping through the garage door window.

A final object of the invention is to provide for multiple windows to be inserted into a single panel of a garage door.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a front view of a garage door with two windows installed.

FIG. 2 is a front view of the garage door of FIG. 1 with two windows installed in a different configuration that was detailed in FIG. 1.

FIG. 3 is a front view of two windows installed in a garage door with divided panels.

FIG. 4 is a front view of the garage door of FIG. 3 with the windows in a different configuration.

FIG. 5 is a front view of a garage door with two windows installed in an open position, with only screens.

FIG. 6 is a front view of the garage door of FIG. 5 with the windows installed in a different configuration, which is an open position, with only screens.

FIG. 7 is a front view of a garage door with two windows installed in an open position, with only screens.

FIG. 8 is a front view of the garage door of FIG. 7 with the two windows installed in a different configuration, which is an open position, with only screens.

FIG. 9 is a front view of the garage door of FIG. 7 with the two windows installed in a different configuration, which is an open position, with only screens.

FIG. 10 is a front view of the garage door of FIG. 7 with the two windows installed in a different configuration, which is an open position, with only screens.

FIG. 11 is a front view of a garage door with two windows installed in an open position, with only screens.

FIG. 12 is a front, close-up view of the pet view door when it is closed.

FIG. 13 is a front, close-up view of the pet view door when it is open.

FIG. 14 is a front, close-up view of the pet view door when it is partially open.

FIG. 15 is a front, close-up view of the pet view door, opened, with horizontal rather than vertical bars.

FIG. 16 is a front, close-up view of the pet view door of FIG. 14, partially opened.

FIG. 17 is a front, close-up view of a pet view door with vertical security bars

FIG. 18 is a front, close-up view of the pet view door of FIG. 17 with a screen, configured as Construction Option 1.

FIG. 19 is a front, close-up view of the pet view door of FIG. 17 partially opened, configured as Construction Option 1.

FIG. 20 is a front, close-up view of a pet view door with horizontal security bars, configured as Construction Option 1.

FIG. 21 is a front, close-up view of a pet view door with a spring-activate screen roller, configured as Construction Option 1.

FIG. 22 is a front, close-up view of the pet view door of FIG. 21 with the window partially open, configured as Construction Option 1.

FIG. 23 is a side view of a garage door panel showing the spring-activated screen roller.

FIG. 24 is a front view of a garage door with air-circulating fans.

FIG. 25 is a front view of the garage door of FIG. 24 with the air-circulating fans in a different configuration.

FIG. 26 is a side view of a garage door panel showing the operation of the air-circulating fan.

FIG. 27 is a back view of one embodiment of the “Pet View Door” embodiment of the invention.

FIG. 28 is a back view of one embodiment of the “Pet View Door” embodiment of the invention.

FIG. 29 is a back view of an 18-pin option of the Ventilation Window Concept.

FIG. 30 is back view of an embodiment of the Ventilation Window Concept, with horizontal security bars.

FIG. 31 is a back view of an embodiment of the Ventilation Window Concept, with clear windows and no security bars.

FIG. 32 is a back view of another embodiment of the Ventilation Window Concept.

FIG. 33 is a back view of yet another embodiment of the Ventilation Window Concept.

FIG. 34 is a back view of an embodiment with horizontal security bars. Ventilation window concept

FIG. 35 is a back view of another embodiment of the invention of the Ventilation Window Concept.

FIG. 36 is a back view of another embodiment of the Ventilation Window Concept.

FIG. 37 is a back view of another embodiment of the Ventilation Window Concept.

FIG. 38 is a back view of another embodiment of the Ventilation Window Concept.

FIG. 39 is a back view of another of the Ventilation Window Concept.

FIG. 40 is a side view of one embodiment of the invention.

FIG. 41 is a side view of another embodiment of the invention.

FIG. 42 is a top view of an embodiment of the invention.

FIG. 43 is a top view of another embodiment of the invention.

FIG. 44 is a side view with sliding door and screen guide rail.

FIG. 45 is a side view of a garage door panel in the Ventilation Window Concept.

FIG. 46 is a back view of a garage door panel showing horizontal bars in a Pet Door Embodiment of the invention.

FIG. 47 is a front view of a garage door panel showing horizontal bars attached in a different manner in a Pet Door Embodiment of the invention.

FIG. 48 is a front view of a garage door panel showing a Ventilation Window Concept with a front window cover.

FIG. 49 is a front view of a garage door panel showing one possible configuration of a garage door with upper sliding windows with the screen closed and lower sliding doors also with screen closed.

FIG. 50 is an exterior front view of another possible configuration of a garage door with the sliding screens in open positions.

FIG. 51 is a top, exploded view of the Sliding “Pet View” Door concept, with Security Bars, with bolt or screw attachments and the parts relative placement to one another.

FIG. 52 is a top, exploded view of an embodiment that illustrates the top view of the sliding “Ventilation Window” concept.

FIG. 53 is a top, exploded view of an embodiment that a top view with a Locking Pin/Pin Latch versus a Locking Hasp assembly. This figure also shows the optional magnet.

FIG. 54 is a side view of the sliding Guide Rails with “bushing” inserts.

FIG. 55 is a side view of the sliding “Ventilation Window”/Screen Guide Rail and Frame assembly with bolt and/or screw attachment.

FIG. 56 is side view that shows a side view of a Sliding “Pet View” Door/Screen Guide Rail and Frame assembly. This embodiment differs from the embodiment of FIG. 44, as FIG. 44 shows bolt fasteners were put in from front of garage door, while FIG. 56 shows bolts from the interior side.

FIG. 57 is a back view that shows a “Pet View” door assembly with the Locking Pin/Pin Latch and optional Magnet being located near the bottom of the assembly verses the top.

FIG. 58 is a back view that shows the “Ventilation Window” assembly with the Locking Pin/Pin Latch, and optional Magnet being located near the bottom of the assembly verses the top.

FIG. 59 is a back view that shows a Locking Hasp/Hasp Latch located near the bottom of the assembly and instead of a Locking Pin/Pin Latch.

FIG. 60 is a back view that shows a Locking Hasp/Hasp Latch located near the bottom of the assembly and instead of a Locking Pin/Pin Latch.

FIG. 61 is a back view that shows no Clip Fasteners are used in a Pet Door version of the invention.

FIG. 62 is a side view that shows the addition of an optional Sliding Window. In this variation of the “Pet View” door concept a clear sliding window would take the place of the solid sliding door that has been featured in all previous figures of the “Pet View” door concept, with an added secondary sliding door in addition to the sliding window.

FIG. 63 is a back view of one potential construction design for the exterior 26 Frame for the “Ventilation Window” concept.

FIG. 64 is a back view of another potential construction design showing the interior view of the exterior frame for the “Pet View” door concept

FIG. 65 is an exploded view of the “Pet View” concept.

FIG. 66 is a back, perspective view of a potential “Pet View” door concept.

FIG. 67 is a perspective view of various parts shown in previous figures for the “Pet View” concept.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

Brief summary of invention: The invention is a modified garage door panel with a built in “Ventilation Window” and/or “Pet View” door. The pet view door would be most effective located as the bottom panel of any garage door for any one, two, or multiple car garage. However, the panel itself can be located at any level within the garage door and can be installed as one or more panels of the garage door offering several ventilation and pet viewing options. The door within the panel itself can also be located at center, right, or left and can consist of one, two, or more doors per panel though optimal usage would be for a minimum of two windows or doors per panel.

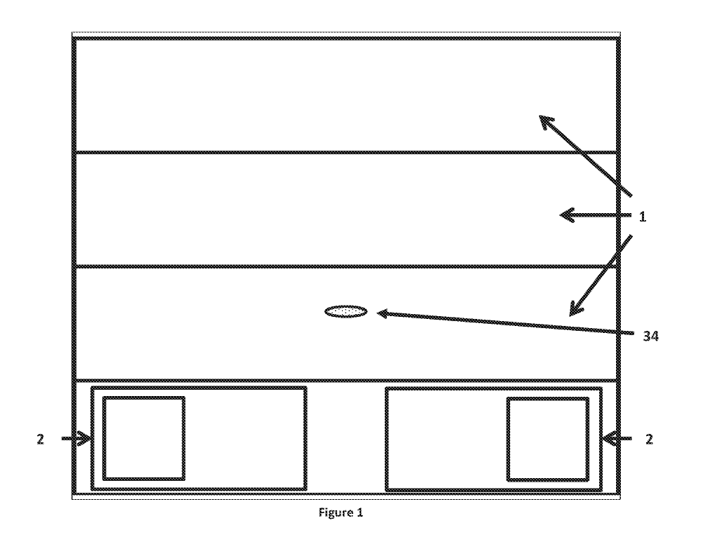

FIGS. 1-11 represent variations as to the location, in the garage door panels, that this “Ventilation Window” or “Pet View” door can be located.

FIG. 1 is a front view of a garage door with two windows installed. The garage door is comprised of multiple panels (1). The bottom panel has the invention (2) installed in two locations. The garage door handle is indicated by 34.

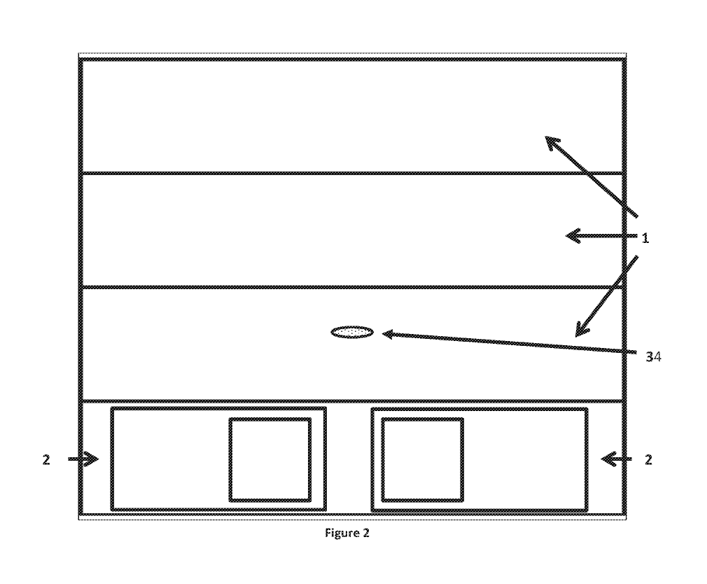

FIG. 2 is a front view of the garage door of FIG. 1 with two windows installed in a different configuration that was detailed in FIG. 1. In this figure, the invention (2) is installed with the window portions at the center rather than the edges of the panel.

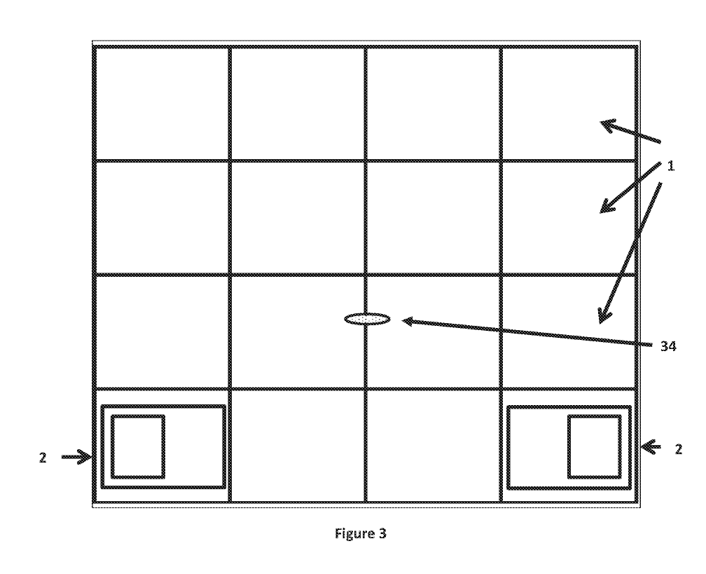

FIG. 3 is a front view of two windows (2) installed in a garage door with divided panels.

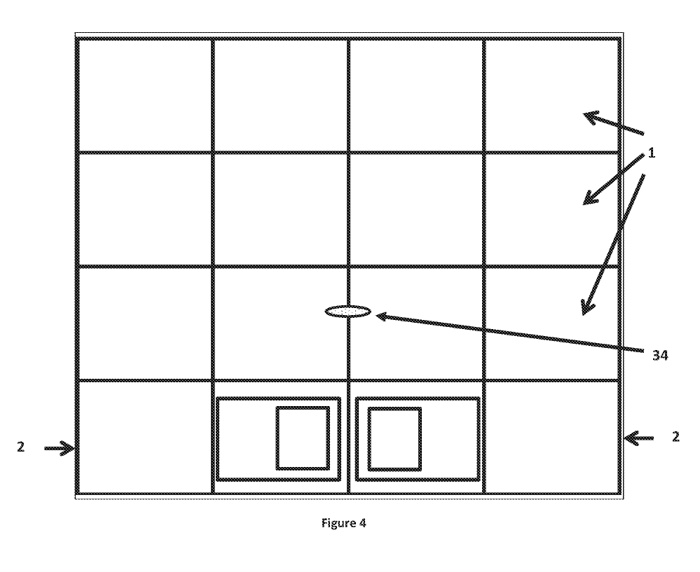

FIG. 4 is a front view of the garage door of FIG. 3 with the windows (2) in a different configuration.

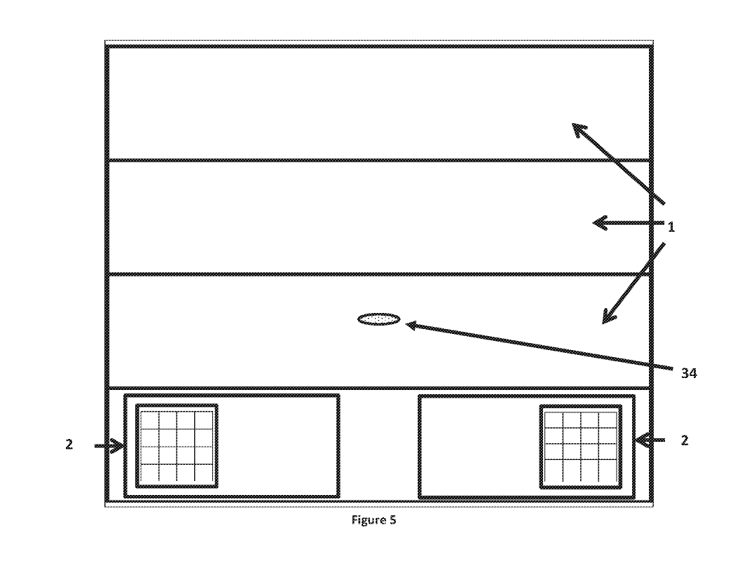

FIG. 5 is a front view of a garage door with two windows installed in an open position, with only screens.

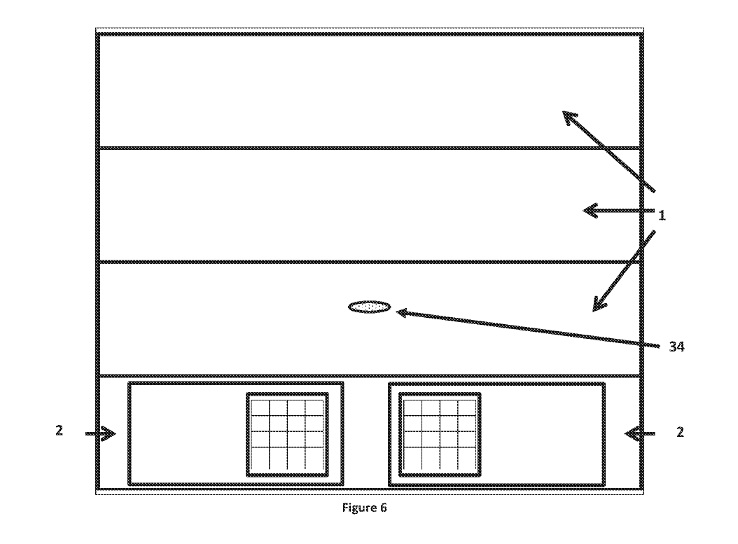

FIG. 6 is a front view of the garage door of FIG. 5 with the windows installed in a different configuration, which is an open position, with only screens.

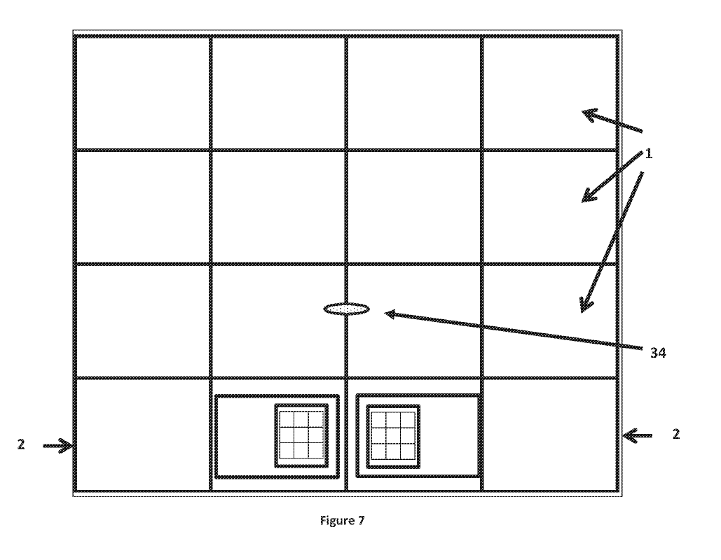

FIG. 7 is a front view of a garage door with two windows installed in an open position, with only screens.

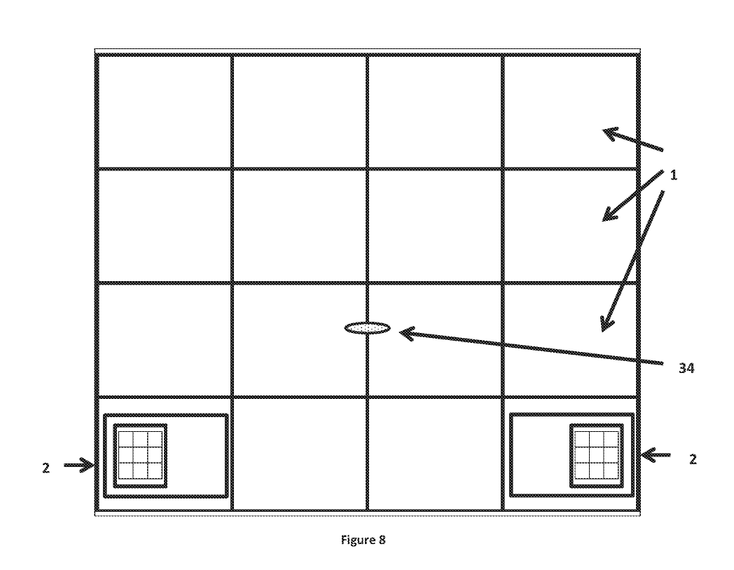

FIG. 8 is a front view of the garage door of FIG. 7 with the two windows installed in a different configuration, which is an open position, with only screens.

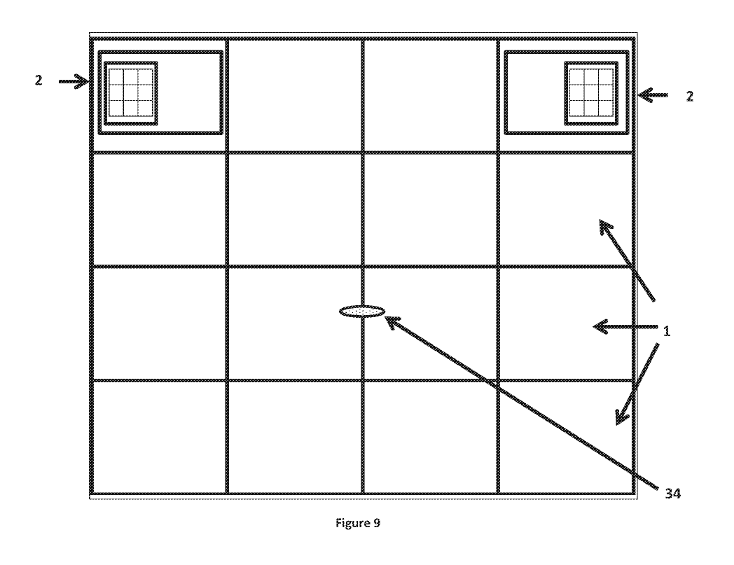

FIG. 9 is a front view of the garage door of FIG. 7 with the two windows installed in a different configuration, which is an open position, with only screens.

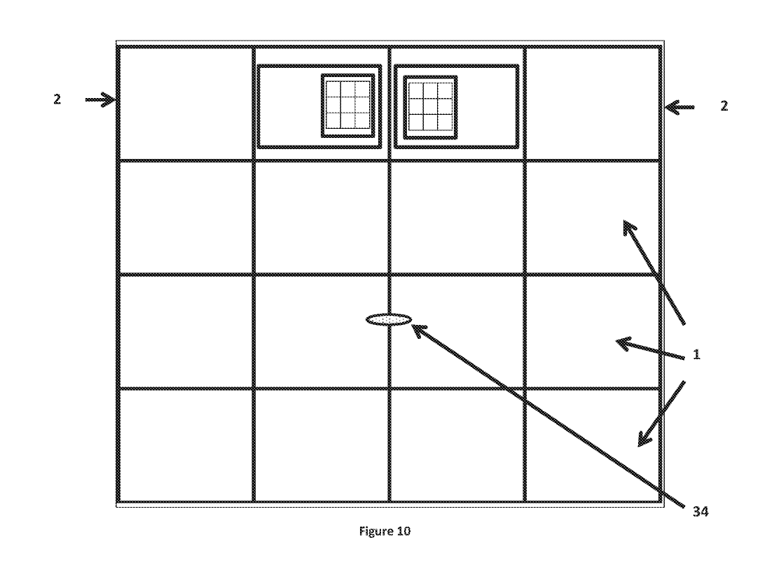

FIG. 10 is a front view of the garage door of FIG. 7 with the two windows installed in a different configuration, which is an open position, with only screens.

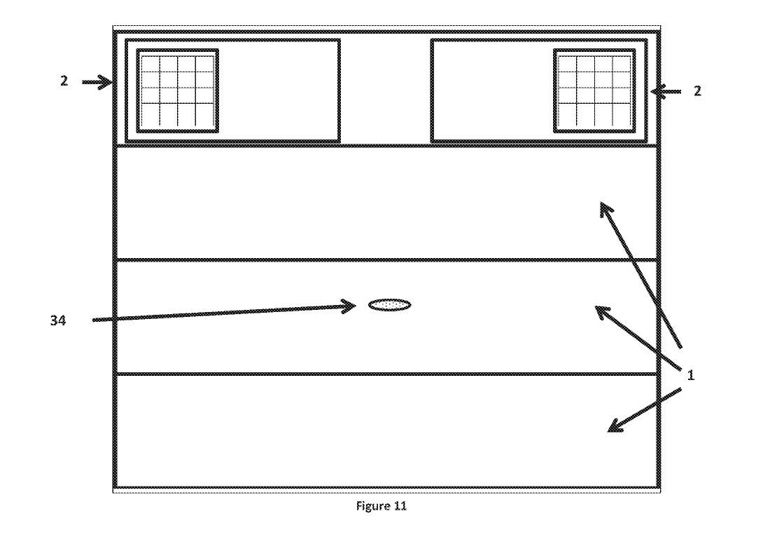

FIG. 11 is a front view of a garage door with two windows installed in an open position, with only screens. The invention works just as well when it is fit into the vertical column, such as illustrated in FIG. 10, or a panel that is uninterrupted from one side of the garage door to the other, as is shown in this illustration. The window can also be rotated 180 degrees such that the opening is located toward the center or toward the edge.

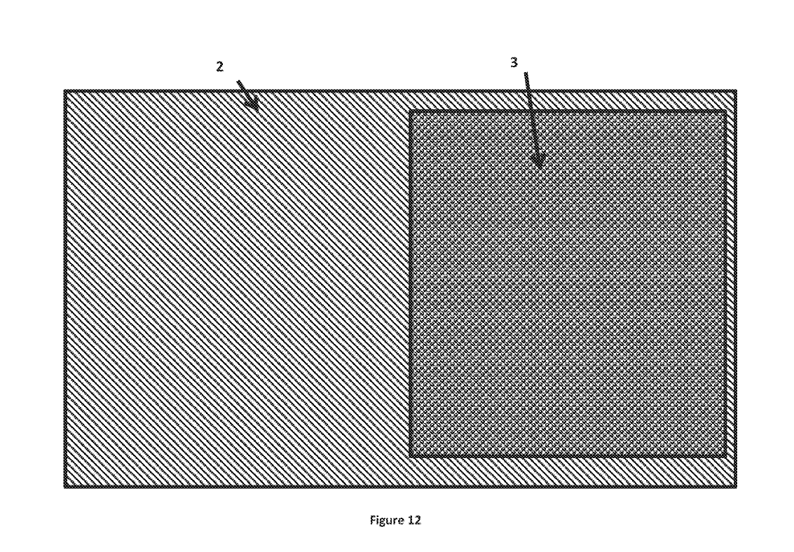

The 2 “Ventilation Window” and “Pet View” Garage Door Panel, (see FIGS. 12-16) would consist of a square or rectangular opening that would have a 3 Sliding Door or window that can be moved right to left and left to right along the 6 Sliding Door and Sliding Screen Guide Rail. It should be noted that FIGS. 12-16 represent only a solid door which would be consistent with the “Pet View” door concept. A clear sliding window would be used for the “Ventilation Window” concept. It is also noted that FIGS. 12-16 are exterior views only.

FIG. 12 is a front, close-up view of the pet view door when it is closed. A sliding door (3) has been slid closed to close off the opening.

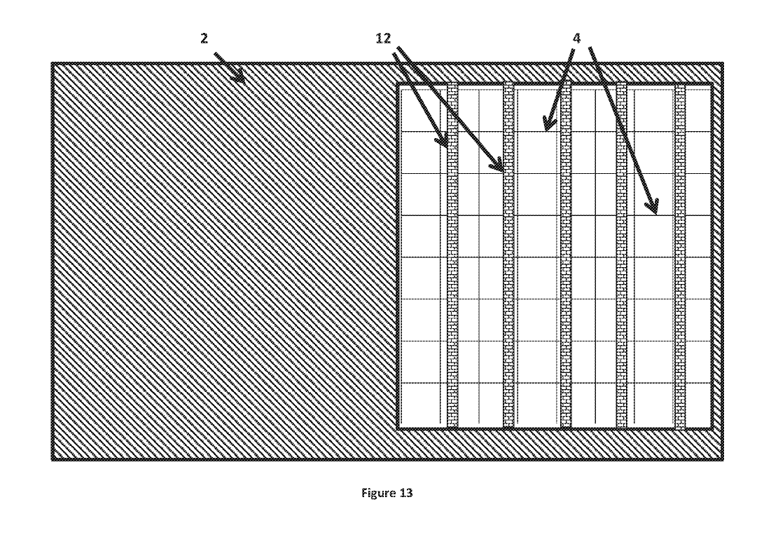

FIG. 13 is a front, close-up view of the pet view door when it is open. A sliding screen (4) prevents insects from getting into the garage while vertical security bars (12) prevent pets from escaping.

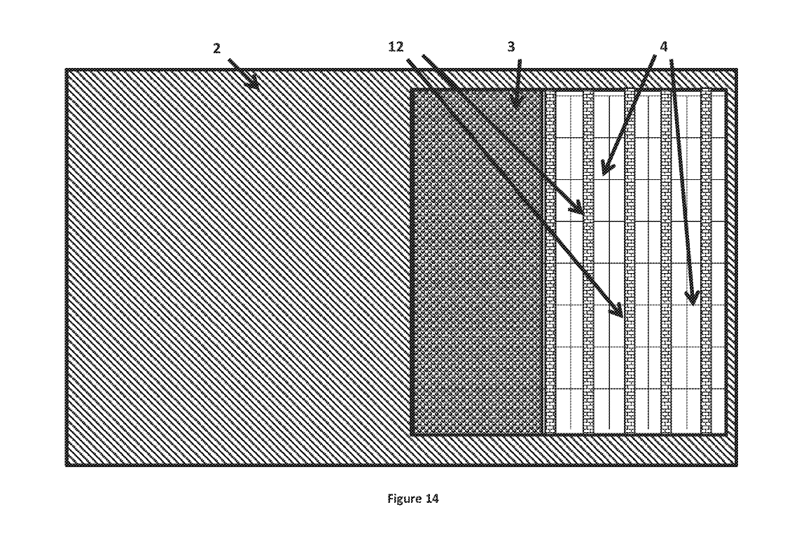

FIG. 14 is a front, close-up view of the pet view door when it is partially open. The sliding door (3) can shut off the opening.

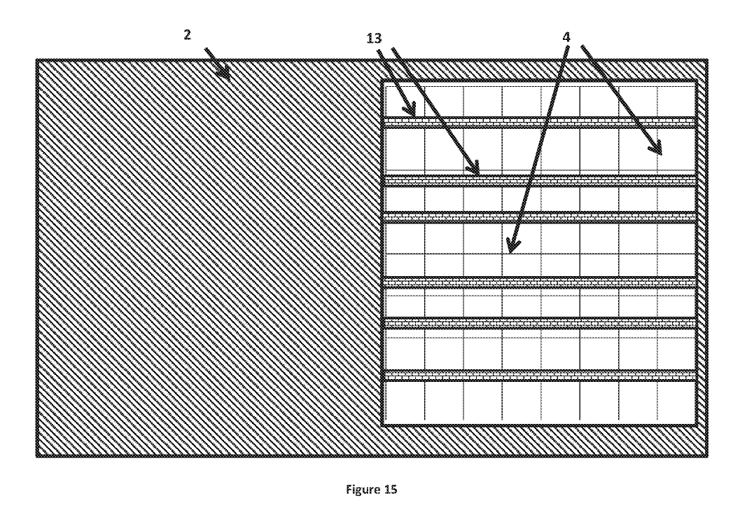

FIG. 15 is a front, close-up view of the pet view door, opened, with horizontal rather than vertical bars.

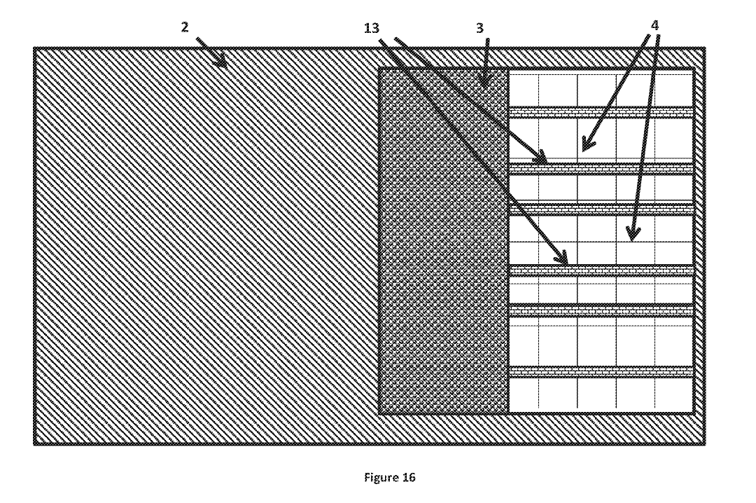

FIG. 16 is a front, close-up view of the pet view door of FIG. 14, partially opened such that a security door cover (3) partially obscures the sliding screen (4) and the horizontal security bars (13). It should be noted that diagonal security bars and other shapes of security bars are contemplated.

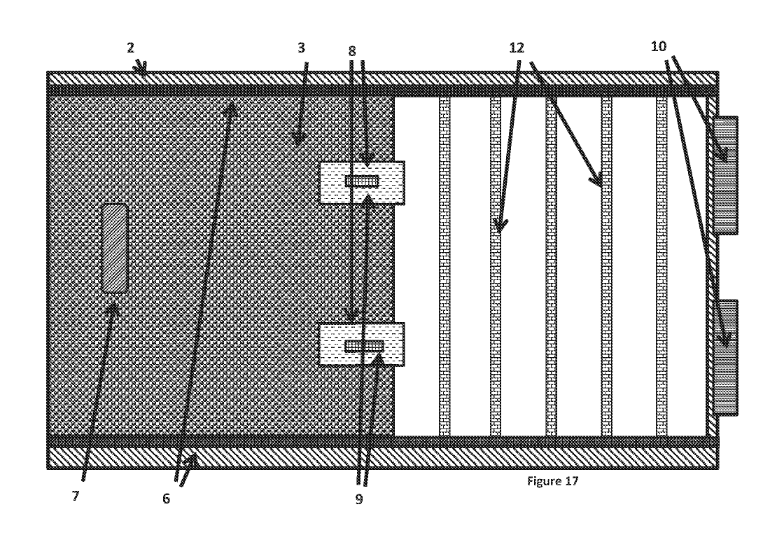

FIG. 17 is a front, close-up view of a pet view door with vertical security bars (12)—basically an open, interior view with vertical security bars. The sliding door (3) has a sliding door handle (7) and sliding door securing brace (8) and a sliding door securing brace screen hook (9). The sliding door handle (7) is a convenient way to open and close the window. The sliding door securing braces (8) mate with sliding door securing brackets (10) to secure the sliding door (3) in a closed position. The sliding door is restricted in its travel by a sliding door and screen guide rail (6)

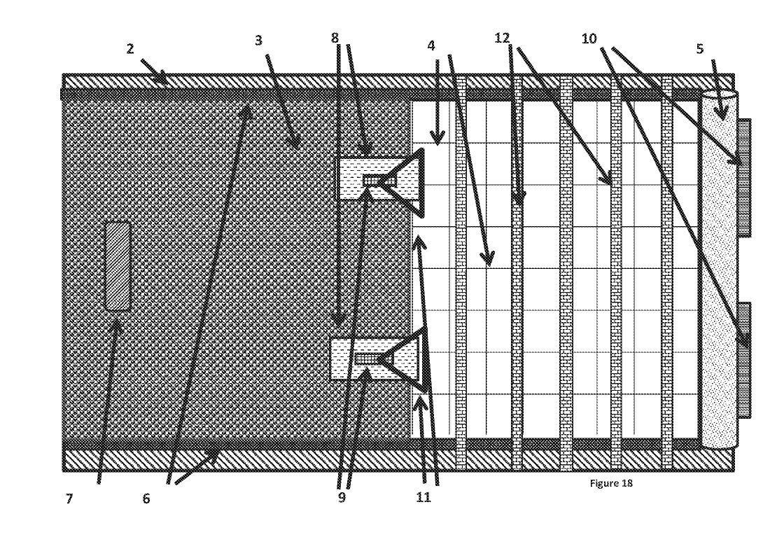

FIG. 18 is a front, close-up view of the pet view door of FIG. 17 with a screen, configured as Construction Option 1, with a sliding screen (4) and a spring-activated screen roller (5). This figure illustrates how the sliding screen (4) can be tensionally-pulled by the opening of the window, and how a spring-activated screen roller (5) keeps the screen taught, and allows for the screen to be retrieved easily as the window is closed.

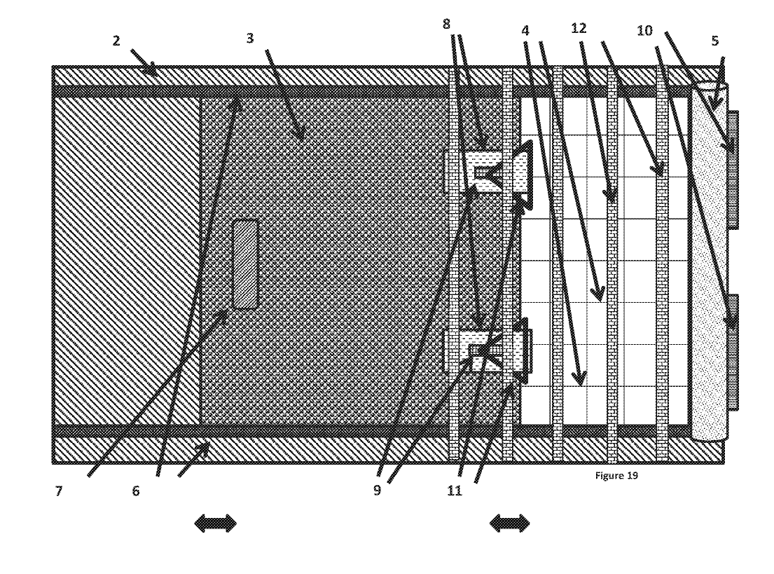

FIGS. 19-22 show the possible configuration of Item numbers 2-13 as follows.

FIG. 19 is a front, close-up view of the pet view door of FIG. 17 partially opened, configured as Construction Option 1. The spring-activated screen roller (5) has retrieved some of the sliding screen (4) as the window has been partially closed.

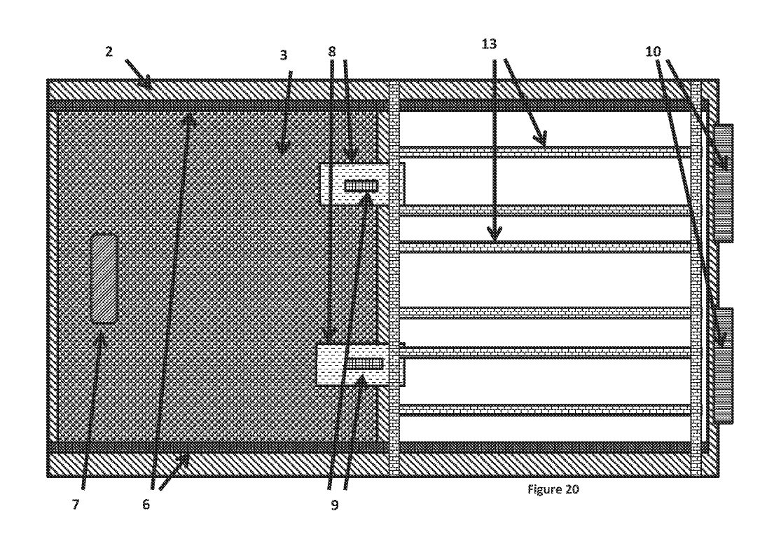

FIG. 20 is a front, close-up view of a pet view door with horizontal security bars, configured as Construction Option 1.

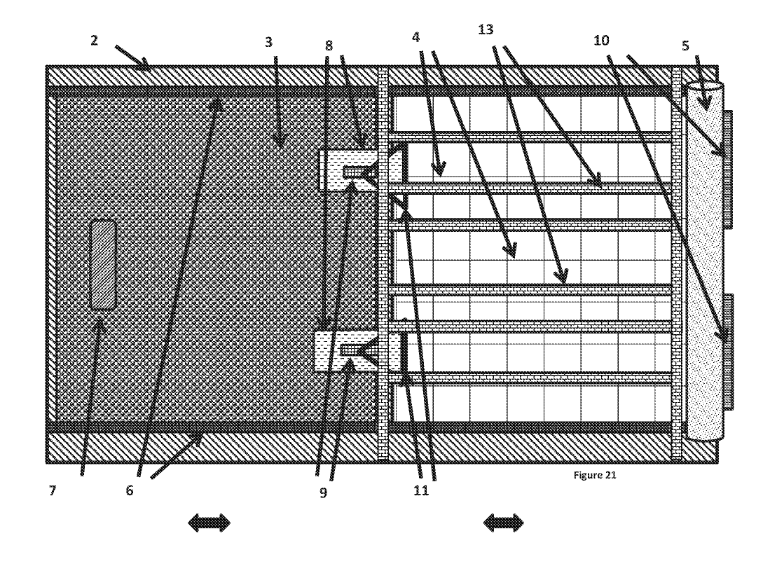

FIG. 21 is a front, close-up view of a pet view door with a spring-activate screen roller, configured as Construction Option 1.

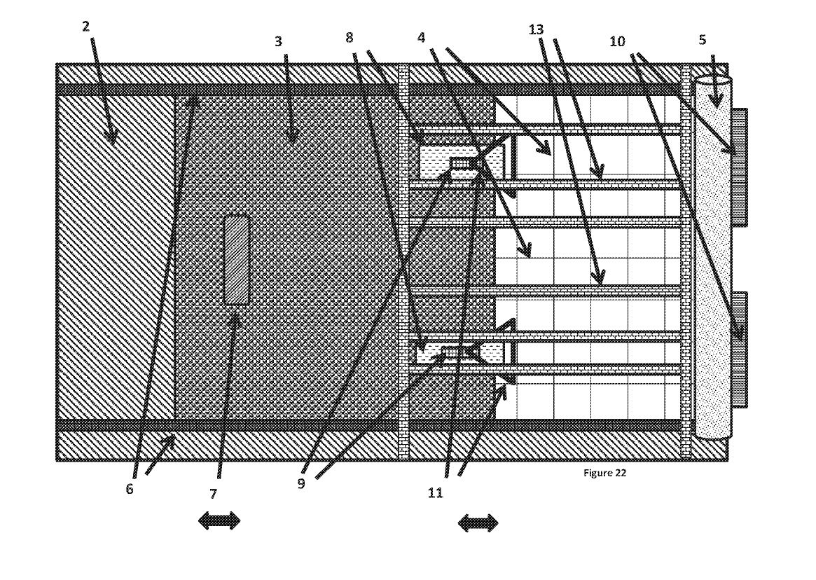

FIG. 22 is a front, close-up view of the pet view door of FIG. 21 with the window partially open, configured as Construction Option 1. The spring-activated screen roller (5) has retrieved some of the sliding screen (4) as the window has been partially closed.

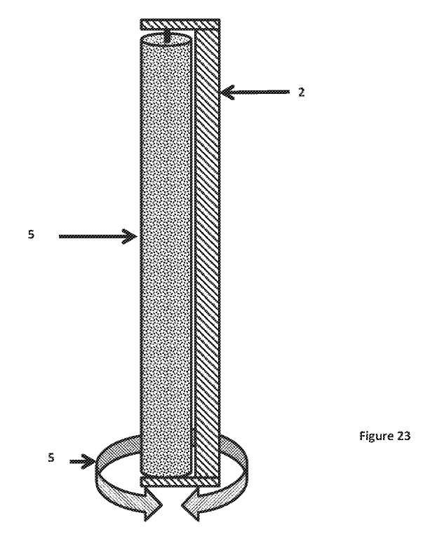

FIG. 23 is a side view of a garage door panel showing the spring-activated screen roller (5), which rotates clockwise to roll up, and counter clockwise to unroll the sliding screen (not shown in this figure). FIG. 23 illustrates the clockwise and counter clockwise movement of the 5 Spring Activated Roller as it coils and uncoils the screen. It is noted that the 5 Spring Activated Screen Roller is an actual housing that protect the screen when the sliding screen is retracted inside. The 4 Sliding Screen coils in and out of the housing.

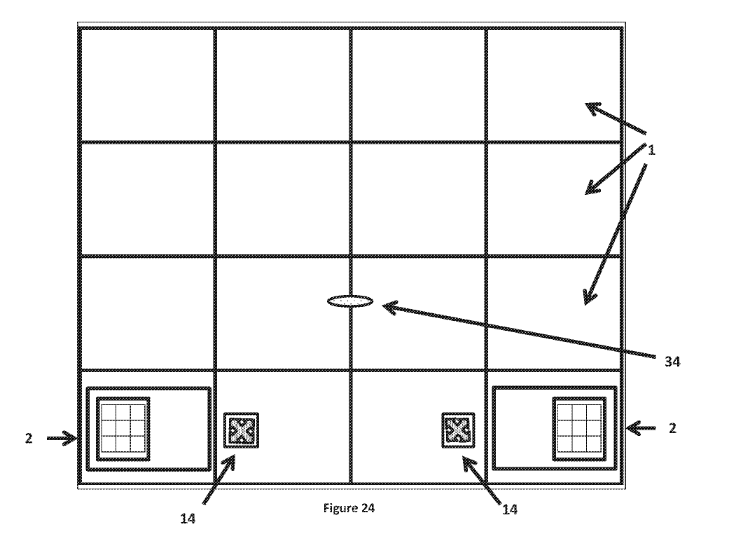

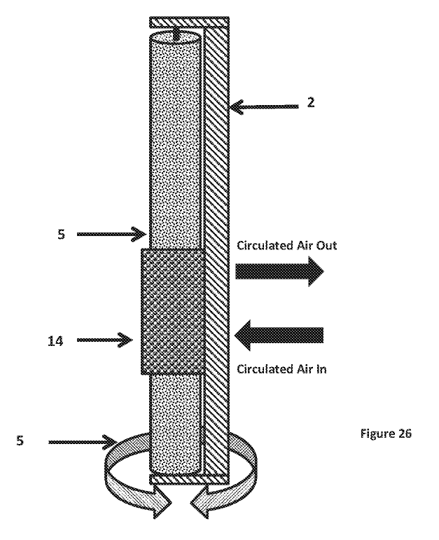

FIGS. 24-26 illustrate potential circulating fans that may be added, as an option. The circulating fans are not generally part of the “Ventilation Window” or “Pet Viewing” door concepts. FIG. 26 is similar to FIG. 23 but with the addition of the air circulating fan.

FIG. 24 is a front view of a garage door with air-circulating fans (14).

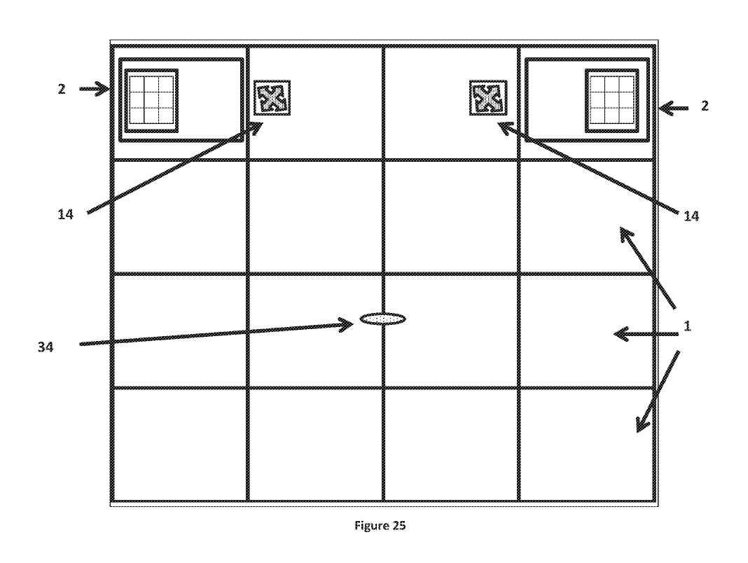

FIG. 25 is a front view of the garage door of FIG. 24 with the air-circulating fans (14) in a different configuration. It is contemplated that the air-circulating fans (14) can be set to pull air in or push air out, and can be assigned different tasks depending on the situation. For example, during hot days, a user may want to have fans on the top panel push out hot air.

FIG. 26 is a side view of a garage door panel showing the operation of the air-circulating fan (15) that has been built into a window.

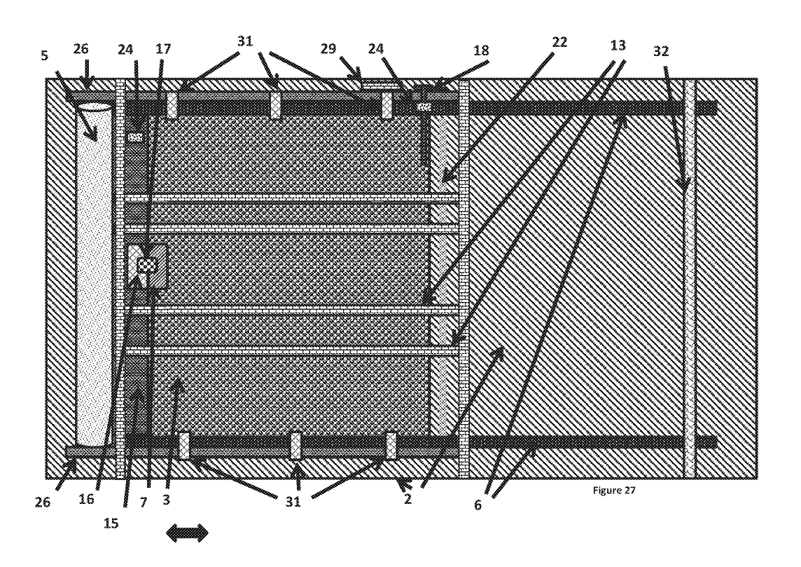

It is mentioned here that the following FIGS. 27-68 are largely a different design concept from FIGS. 17-26 and should be considered accordingly. These changes are being presented to take into consideration different manufacturers' garage door designs. In FIGS. 1-26 the Spring Activated Roller is on the right. In FIGS. 27-60 the 5 Spring Activated Roller is on the left. It can, however, be located, for any design, on the right or left.

FIGS. 27-68 are modified construction options, from the previously filed FIGS. 1-26, to allow for the adaptation to various different door designs, manufacturers, and choice of the consumer. One potential design modification would mainly, but not completely, be changes to the opening and locking aspects. One option change would be to have an added 15 Screen Roller Screen Support Bar that would attach to the 4 Sliding Screen and assist in the opening and closing of the screen. Attached to the 15 Support Bar would be a 16 Screen Roller Support Bar Handle. Also attached to the 15 Support Bar would be a 24 Locking Pin Latch or a 19 Locking Hasp Latch depending upon whether an 18 Locking Pin or 25 Locking Hasp is used for that particular design. Any design could have either a 3 Sliding Door or a 20 Clear Sliding Window. It is assumed, but not necessary, that a solid 3 Sliding Door would be the choice of preference when the concept is used at or near the bottom of the garage door panel for security reasons and the option of the 20 Clear Sliding Window and 21 Clear Stationary Window would be the choice of preference when the concept is used at or near the top of the garage door panels. In either option a 7 Sliding Door Handle would be attached to either the 3 Sliding door or 20 Clear Sliding Window to help facilitate with opening and closing. Also available would be a removable 17 Handle Securing Clip that can be attached to the 16 Support Bar Handle and 7 Sliding Door Handle or 23 Sliding Window Handle. When attached the 17 Securing Clip would keep both the 16 Support Bar Handle and either the 7 Sliding Door Handle or 23 Sliding Window Handle firmly together as seen in FIGS. 27-29, 32-34, and 36-37. When the 17 Securing Clip is removed it allows for the 3 Sliding Door or the 20 Clear Sliding Window to slide right to left or left to right independently from the 15 Screen Roller Screen Support Bar and 4 Sliding Screen.

To operate the concept, to an open position, a person would grasp the 7 or 23 Handle and slide the 3 Door or 20 Sliding Window to the right or left if the 5 Spring activated roller is on the right. The 3 Door or 20 Sliding Window would slide back and forth along the 6 Sliding Door and Sliding Screen Guides.

FIG. 27 is a back view of one embodiment of the “Pet View Door” embodiment of the invention.

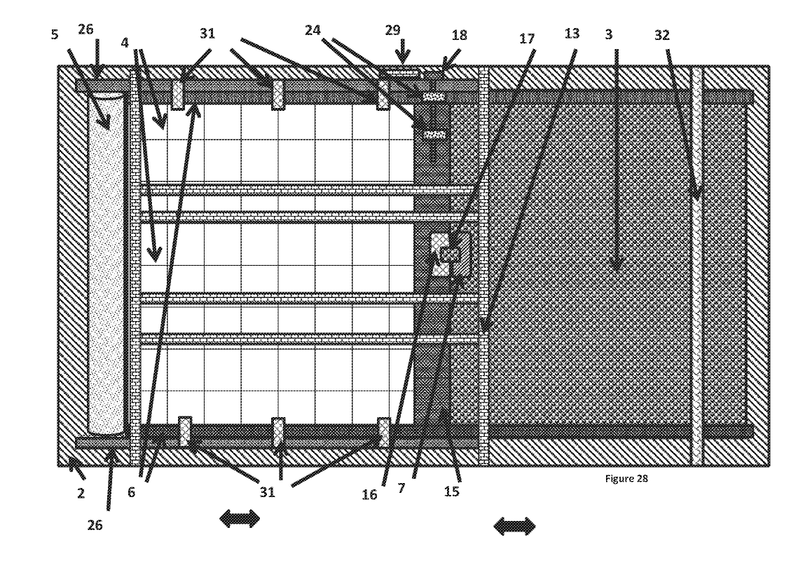

FIG. 28 is a back view of one embodiment of the “Pet View Door” embodiment of the invention. In this embodiment, the solid 3 Sliding door is in an open position, to the right, with the 17 Securing Clip attached. When the 17 Securing Clip is attached the 15 Screen Roller Support Bar, and thus the 4 Sliding Screen, is automatically slid and opened to the right. The screen would open to cover the now open area previously covered by the 3 Door Cover. In this open position the 18 Locking Pin would slide into the 24 Locking Pin Latch to firmly hold the door in the open position. The 18 Locking Pin would be removable but also secured, when in the locked position, to the 6 Screen Guide Rails and/or the 26 Frame via an additional 24 Locking Pin Latch. The 13 Horizontal Security Bars would be attached to the actual garage door panel and be configured to allow easy movement of all moveable parts from left to right or right to left. The 13 Security Bars are an option, presumed to be preferred when the concept is located near or at the bottom of the garage door panels. (Clip fasteners 31 were added).

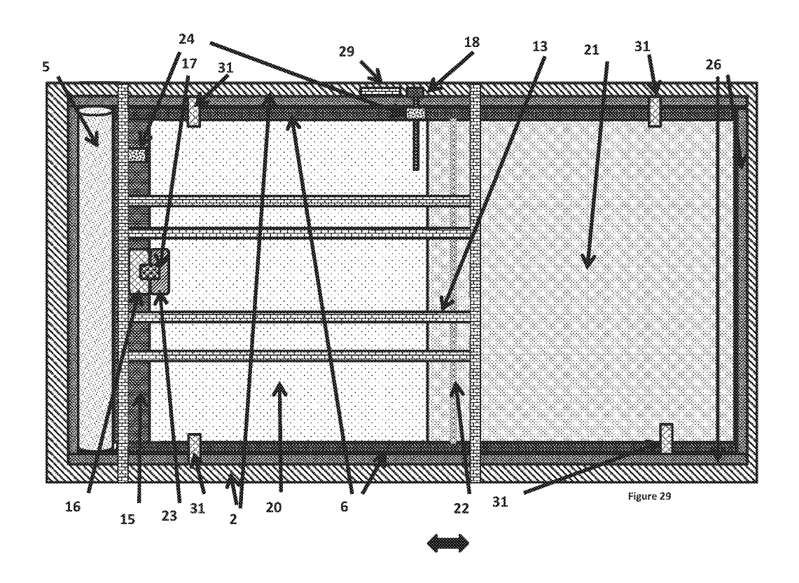

FIG. 29 is a back view of an 18-pin option of the Ventilation Window Concept. It is an illustration of a closed option with a 20 Clear Sliding Window and a 21 Stationary Window. This concept is virtually the same as FIG. 27 but with clear door options versus solid door options. Also added is the 22 Insulation Strip, also seen in several other Figures. The 22 Insulation Strip would be attached to either the 2 Garage Door Panel or the 21 Stationary Window and would fill the gap between the 2 Garage Door Panel and 3 Sliding door or the 21 Stationary Window and the 20 Sliding Window. It would allow movement of either the 3 Sliding door or 20 Sliding Window to move freely over it but remain in place insulating the gap between the parts. Item 29 is a magnet, attached to the 26 Frame, used to secure the 17 Handle Securing Clip and/or the 18 Locking Pin when not in use.

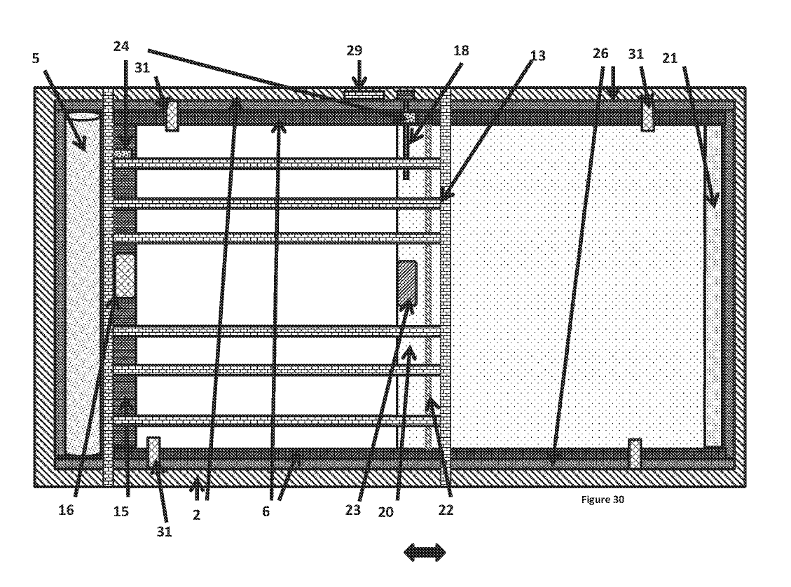

FIG. 30 is back view of an embodiment of the Ventilation Window Concept, with horizontal security bars. It is an illustration of a 20 Clear Sliding Window and a 21 Stationary Window in an open position. In this illustration the 17 Handle Securing Clip is removed thus allowing the 20 Sliding Window to move to the right and over the 21 Stationary Window all the while allowing the 16 Support Bar Handle and 4 Sliding Screen to stay in a closed position.

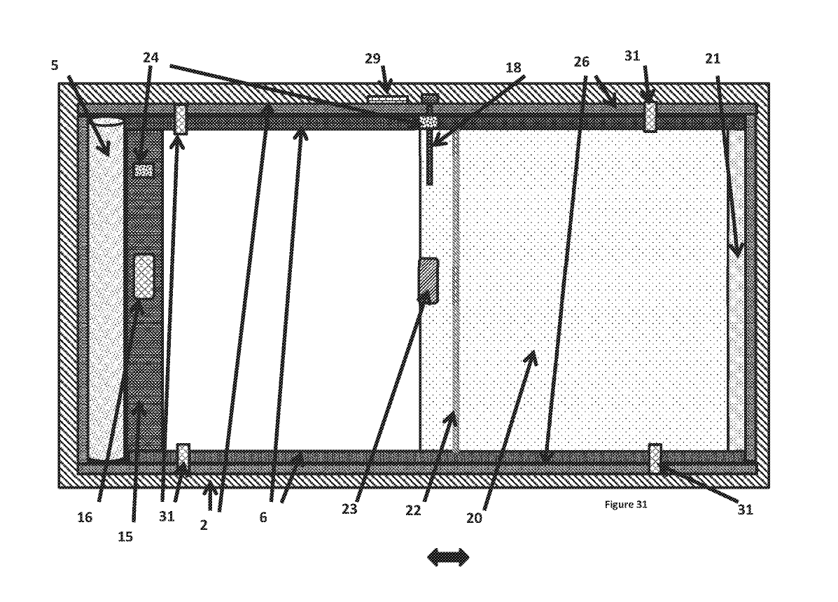

FIG. 31 is a back view of an embodiment of the Ventilation Window Concept, with clear windows and no security bars. FIG. 31 is similar to FIG. 30 but with the no-security-bar option.

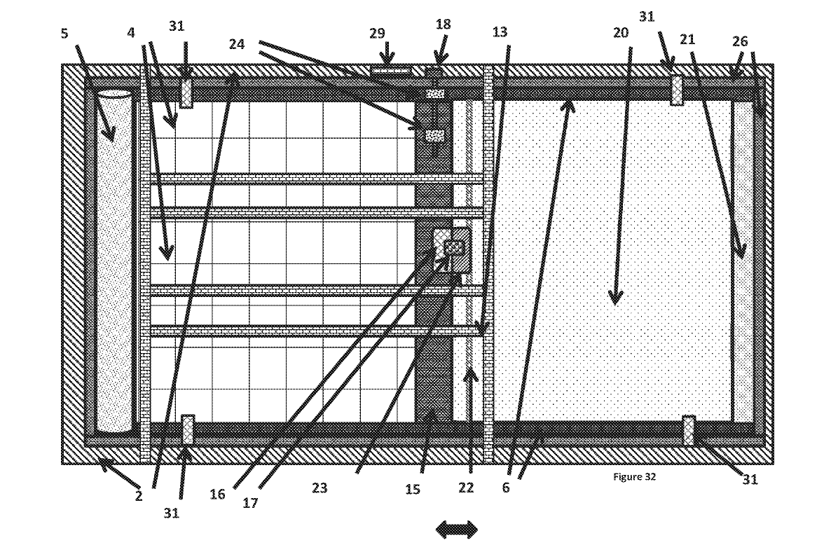

FIG. 32 is a back view of another embodiment of the Ventilation Window Concept. FIG. 32 is an illustration of the clear window option with the 13 Security Bars. Also, in this illustration the 17 Handle Securing Clip is in place, thus, when the 20 Sliding Window is moved to the right the 15 Screen Roller Screen Support Bar and attached 4 Sliding Screen is also moved to the right and secured in the open position by the 18 Locking Pin and 24 Locking Pin Latch.

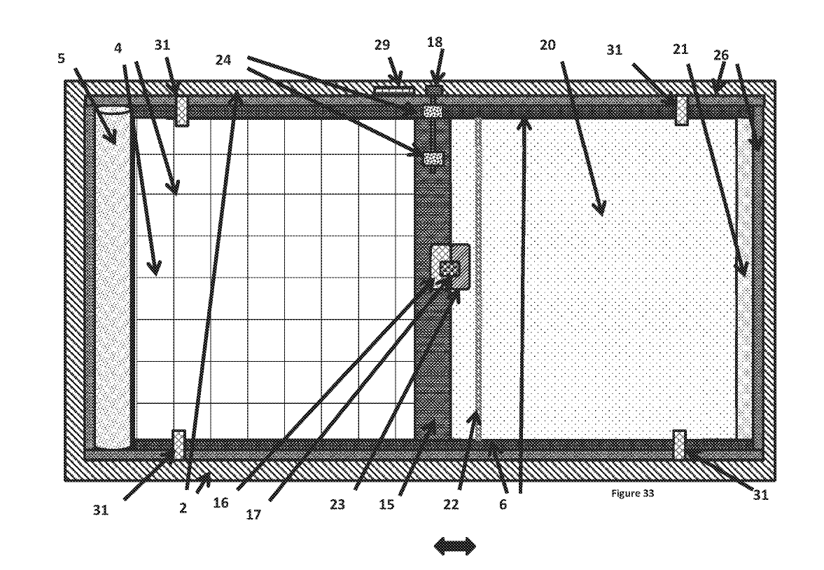

FIG. 33 is a back view of yet another embodiment of the Ventilation Window Concept. FIG. 33 is an illustration similar to FIG. 32 but with no security bars.

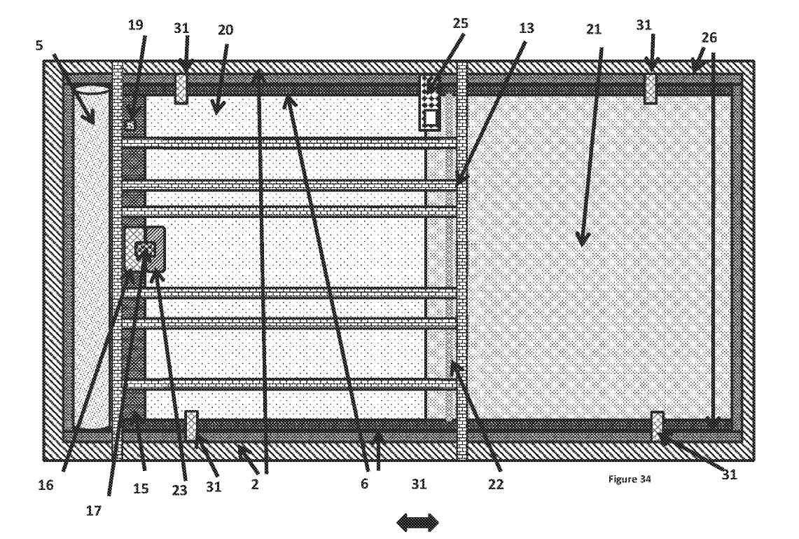

FIG. 34 is a back view of an embodiment with horizontal security bars. Ventilation window concept. FIG. 34 is similar to FIG. 29 but with a 19 Locking Hasp Latch and a 25 Locking Hasp instead of the 24 Locking Pin Latch and the 18 Locking Pin.

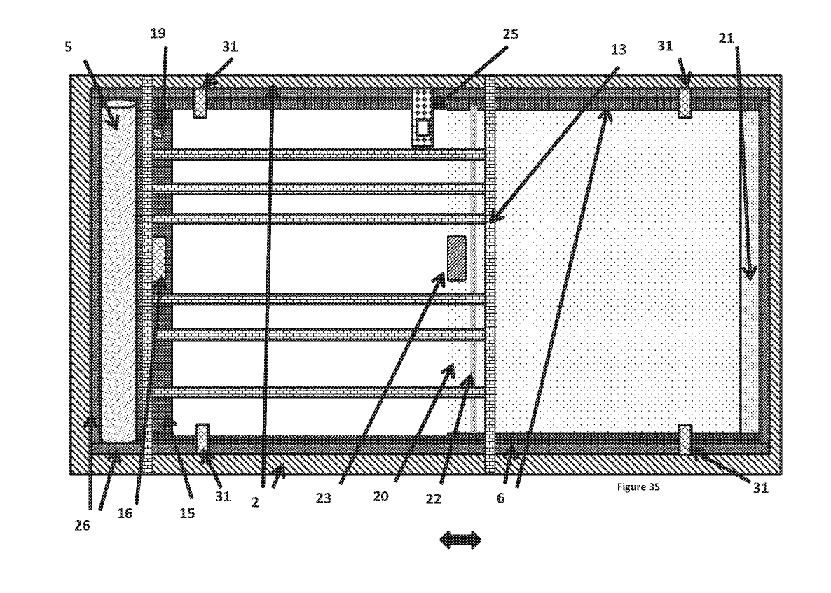

FIG. 35 is a back view of another embodiment of the invention of the Ventilation Window Concept. FIG. 35 is similar to FIG. 30 but with a 19 Locking Hasp Latch and 25 Locking Hasp instead of the 24 Locking Pin Latch and the 18 Locking Pin.

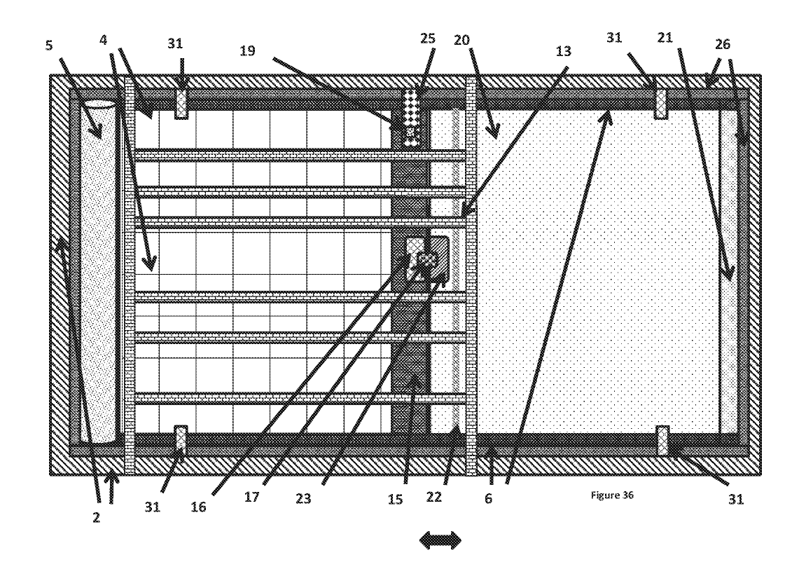

FIG. 36 is a back view of another embodiment of the Ventilation Window Concept. FIG. 36 is similar to FIG. 32 but with a 19 Locking Hasp Latch and 25 Locking Hasp instead of the 24 Locking Pin Latch and the 18 Locking Pin.

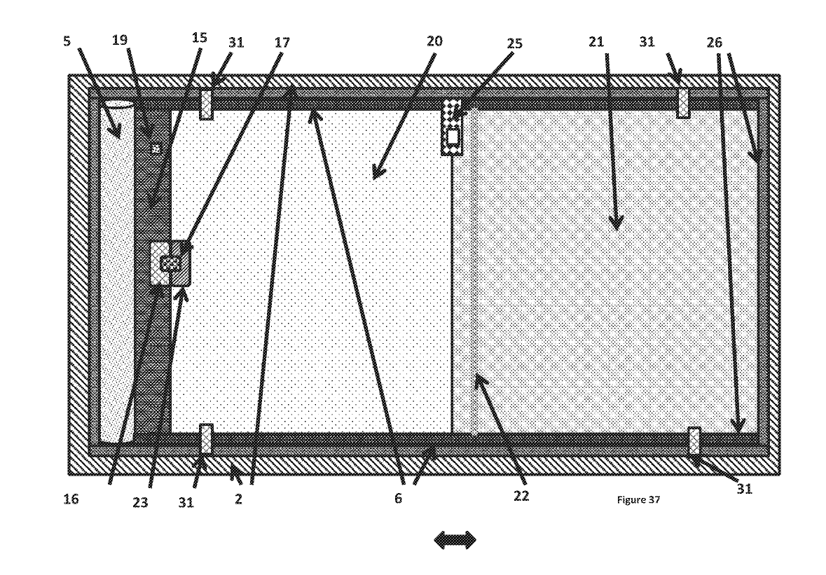

FIG. 37 is a back view of another embodiment of the Ventilation Window Concept. FIG. 37 is an illustration similar to FIG. 34 but with no 13 Security Bars.

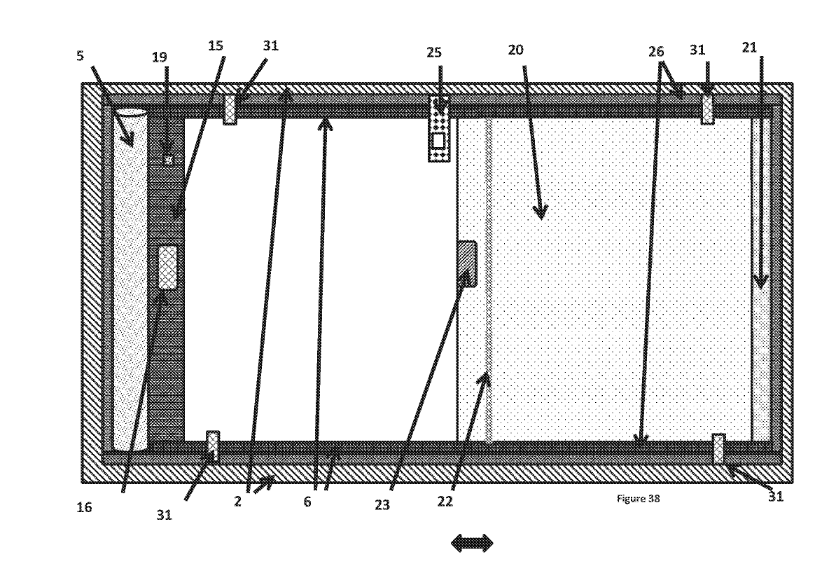

FIG. 38 is a back view of another embodiment of the Ventilation Window Concept. FIG. 38 is similar to FIG. 35 but with no security bars.

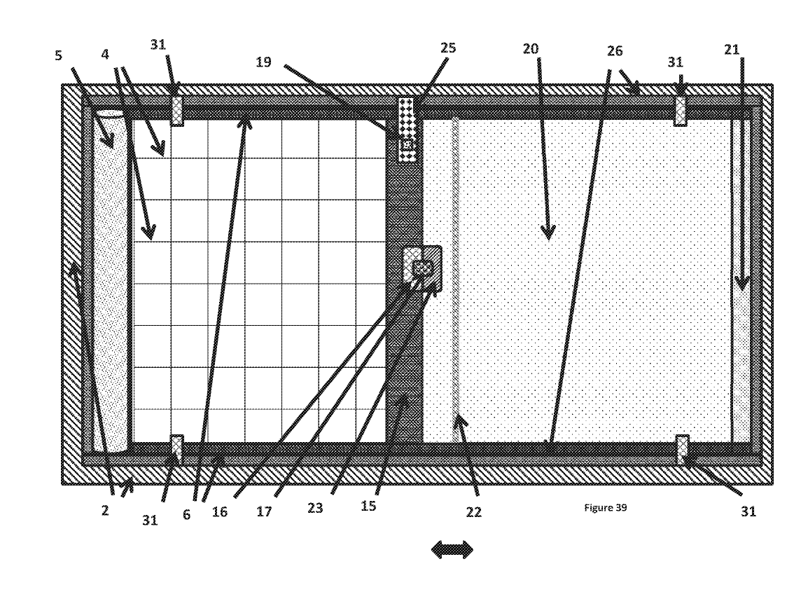

FIG. 39 is a back view of another of the Ventilation Window Concept. FIG. 39 is similar to FIG. 32 but with no security bars. It should be noted that in all Figures with the 19 Locking Hasp Latch and 25 Locking Hasp the 19 Locking Hasp Latch would be attached to the 15 Screen Roller Screen Support Bar. The 25 Locking Hasp would be attached to either the 16 Sliding Door and Screen Guide or the 26 Frame, depending upon the garage door manufacturers' garage door style. In all cases the 25 Locking Hasp would be a pivotal hasp that would fold down over the inserted 19 Locking Hasp Latch and secure the 3 Sliding door or 20 Sliding Window in an open position, in lieu of a Locking Pin assembly. It is assumed, but not necessarily, that the Locking Pin assembly, rather than the Locking Hasp assembly, would be used more in cases when the concept includes security bars. The Locking Pin assembly would be easier to slide in and out behind the Security Bars, whereas, the Hasp assembly, due to its pivotal nature, would have to fold either over or under the security bars. The final determination would be based on the garage door manufacturers' garage panel style.

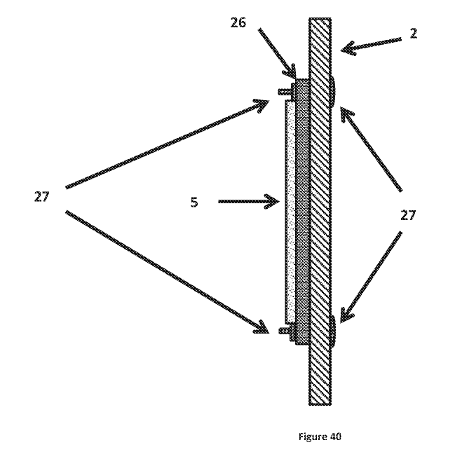

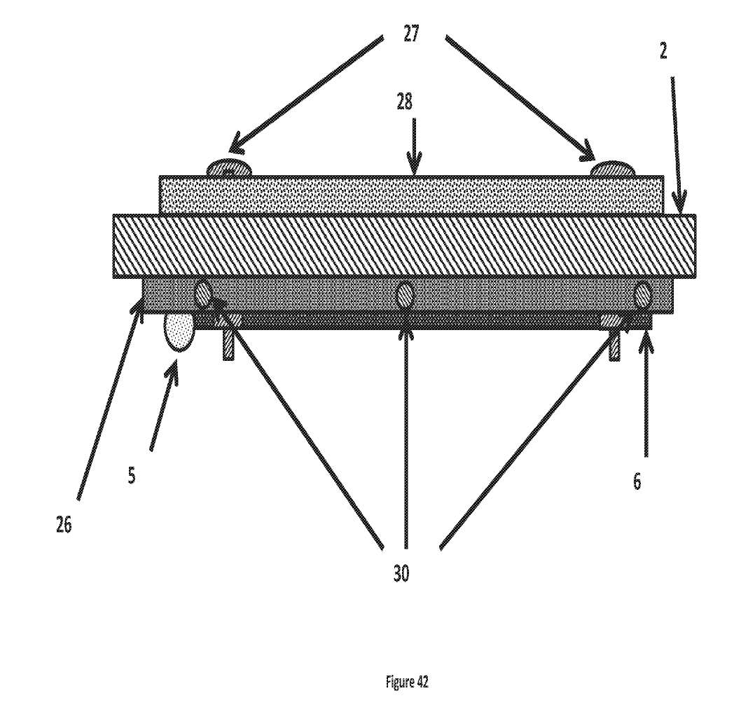

FIG. 40 is a side view of one embodiment of the invention. FIG. 40 is a side view illustration where the 26 Frame is affixed directly to the garage door panel. This view has 5 Spring Activated Roller on side closest to person viewing this illustration, thus no 6 Sliding Guide Rail is visible. Also, no 27 Fasteners are shown on side of frame. 27 Fasteners in this illustration are located for top portion of frame. See FIG. 42. See illustration 44 for complete side view.

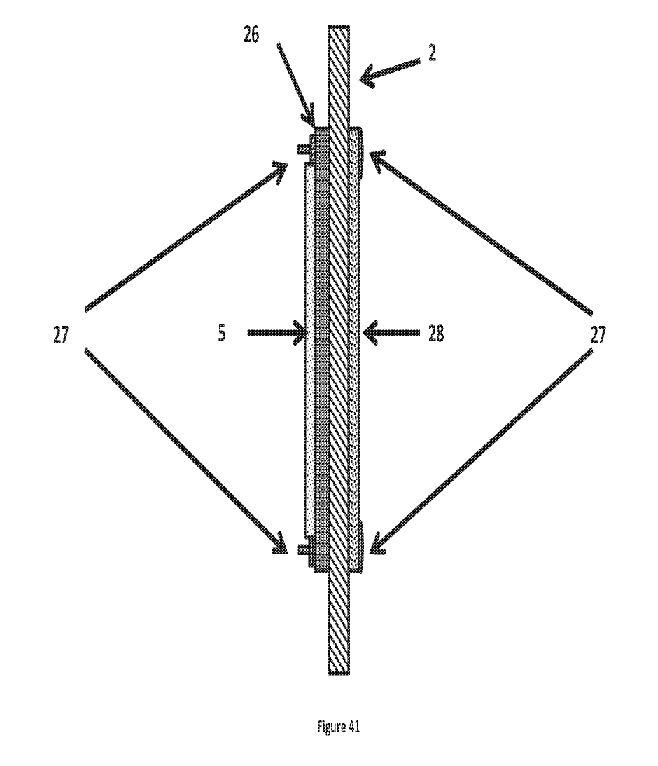

FIG. 41 is a side view of another embodiment of the invention. FIG. 41 is a side view illustration with the additional attachment of a decorative window cover or other type of front cover. There are numerous style/types of front covers offered by garage door manufacturers. This concept can be adapted to most all of them. This view has 5 Spring Activated Roller on side closest to person viewing this illustration, thus no 6 Sliding Guide Rail is visible. Also, no 27 Fasteners are shown on side of frame. 27 Fasteners in this illustration are located for top portion of frame. See FIG. 42. See illustration 44 for complete side view.

FIG. 42 is a top view of an embodiment of the invention. FIG. 42 is a top view illustration were the 6 Sliding Door and Sliding Screen Guide Rails are off set into the frame and are attached to the frame via 30 Bolt or Screw Frame Fasteners. Items to note, FIGS. 27-41 have the addition of the 26 Frame that FIGS. 1-26 did not have. It is a Frame that houses and allows attachment of the 5 Spring Activated Roller, 6 Sliding Door and Sliding Screen Guide Rails, 24 Locking Pin Latch and/or 25 Locking Hasp and/or other enhancements. The 26 Frame can be held in place on the 2 Garage door Panel with either screws, bolts, specially designed clips, or other methods depending upon the garage door manufacturers model type.

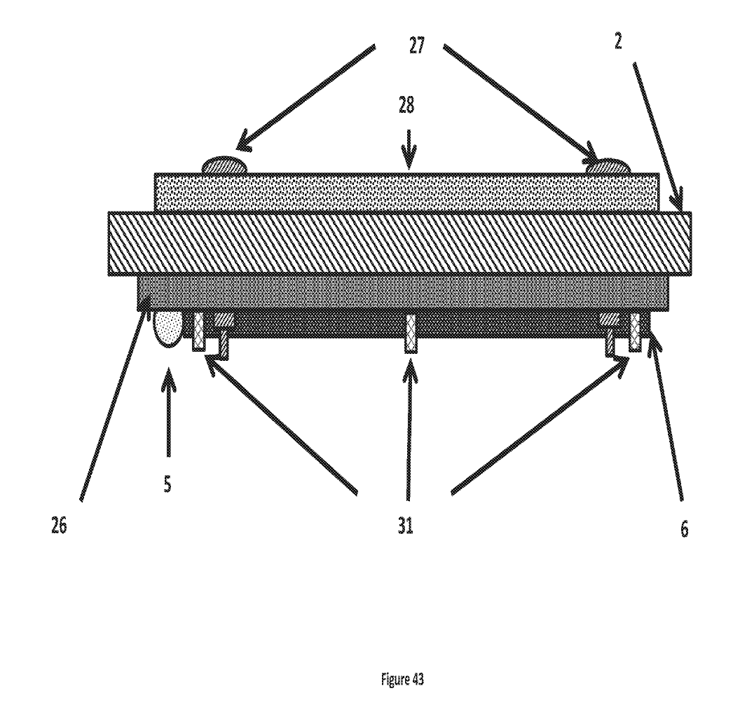

FIG. 43 is a top view of another embodiment of the invention. FIG. 43 is a top view with the 6 Sliding door and Sliding Screen Guide Rail similar to FIG. 42 but with 31 Clip Attachments instead of the Screws/Bolts

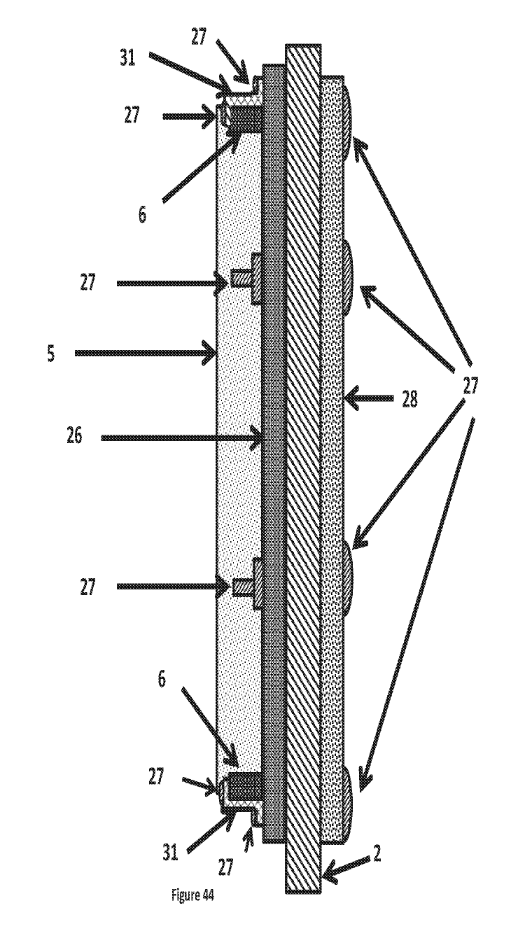

FIG. 44 is a side view with a sliding door and a screen guide rail. FIG. 44 is a side view with one upper and one lower 27 Fastener attaching the horizontal 26 Frame and the horizontal portion of the 28 Window/Front Cover to the 2 Garage Door Panel and two centers 27 Fasteners attaching the vertical portion of the 26 Frame and 28 Window/Front Cover to the garage door panel. It also shows the 31 Clip Fasteners (offset design) attaching the 6 Guide Rail to the 26 Frame. It is understood that there are numerous garage door manufacturers and that each have at least several garage door types. The 26 Frame and accompanying 4 Sliding Screen, 5 Screen Activated Roller, 6 Guide Rails, etc. can be modified in length and/or width to fit any garage door manufacturers size and style of garage door panel and/or window configuration.

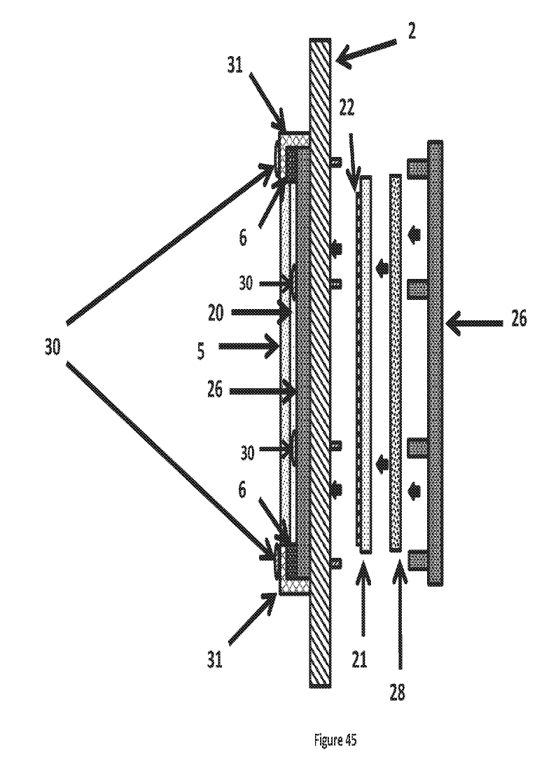

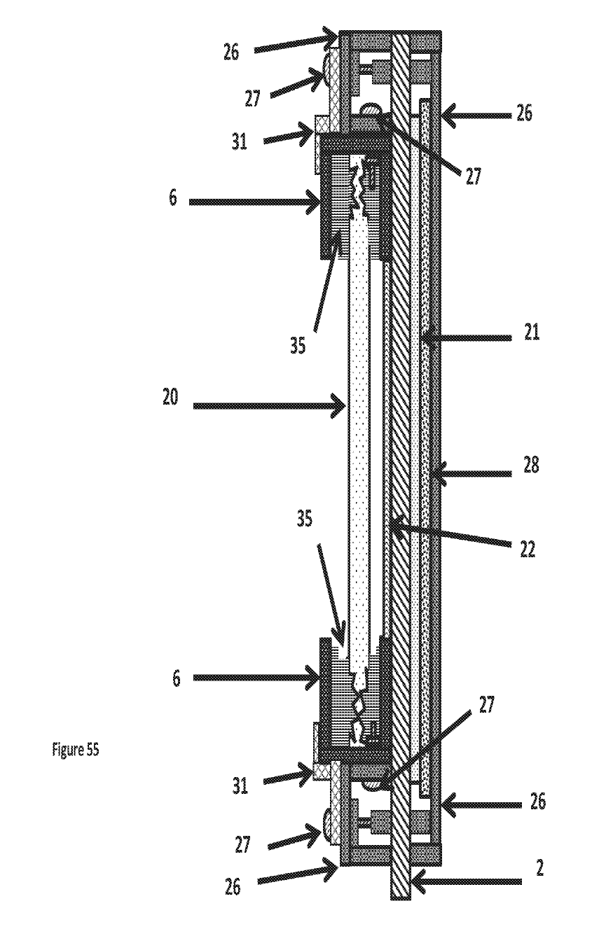

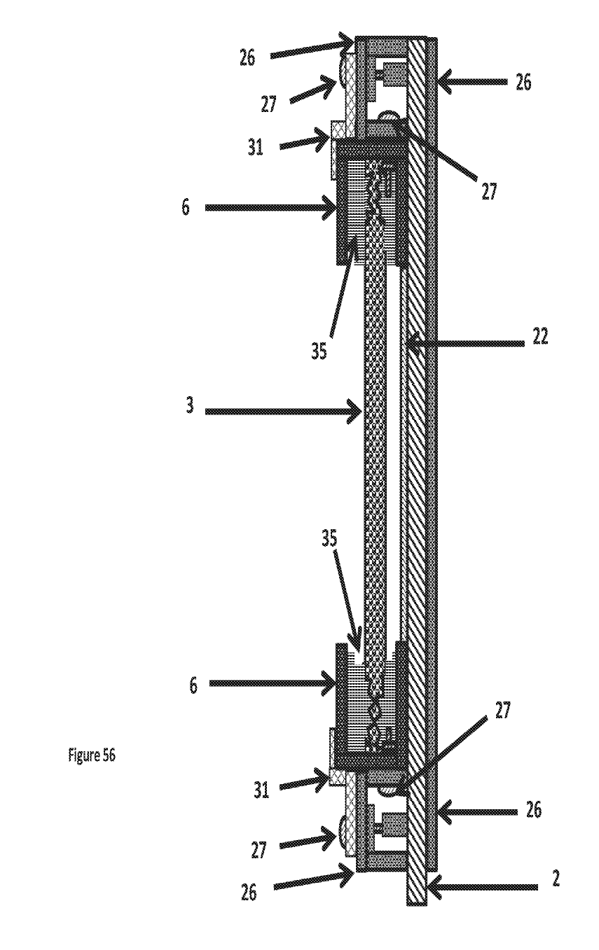

FIG. 45 is a side view of a garage door panel in the Ventilation Window Concept showing horizontal bars. FIG. 45 is the same format and design as previously submitted designs with the exception of the configuration of the 13 Horizontal Security Bars. In this figure the security bar assembly consists of the two vertical support bars but only four horizontal bars instead of the previously submitted six bar configurations. FIG. 45 is similar to FIG. 44 but in FIG. 45 a different, “Option 2”, is used to secure the Clip Fasteners, Guide Rail, and frames together. In this figure the 30 Fasteners are inserted from the interior of the garage door, through the interior frame, versus through the exterior frame and exterior of the garage door. Also shown in this Figure is a modified version of the exterior frame showing top, bottom, and side frame “extensions” that when the exterior frame is placed against the exterior of the garage door panel these “extensions” would fit through the opening in the garage door panel and allow the 30 securing screws to be tightened directly into these “extensions” allowing for the interior and exterior frames to be tightened snugly against the garage door panel. The 21 Stationary Window and optional 28 window cover, if used, would fit against and inside the exterior frame and also be tightened snugly between the interior and exterior frame. Also see FIGS. 55 and 56 for additional side view illustrations. Also added is the 22 Insulation Strip, seen in several other Figures.

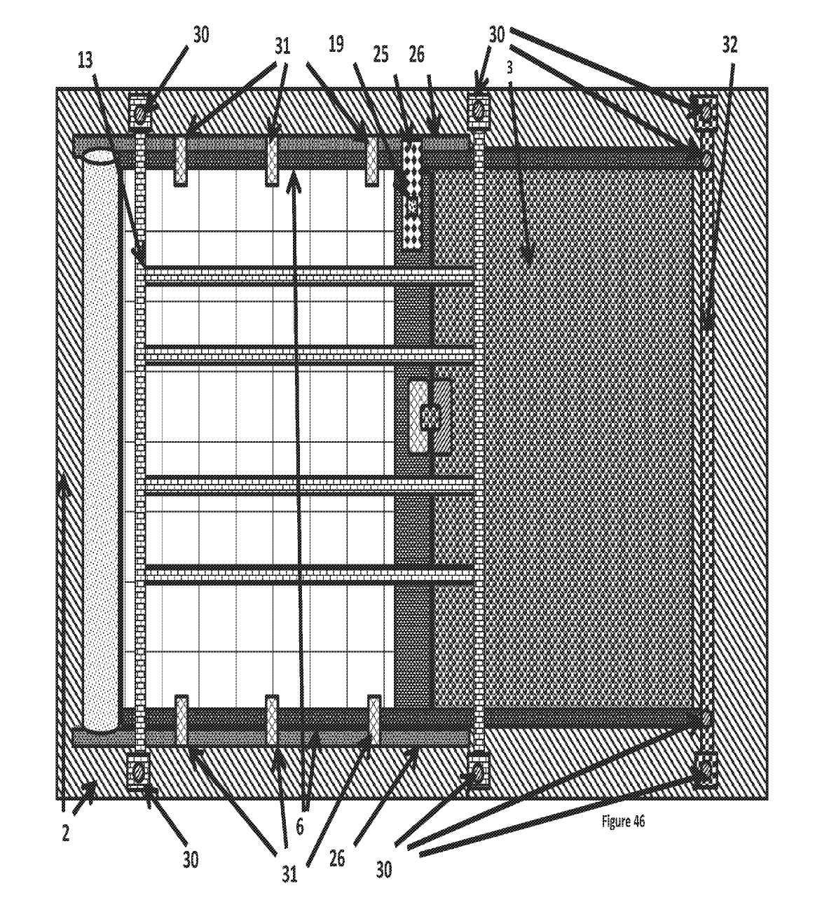

FIG. 46 is a back view of a garage door panel showing horizontal bars in a Pet Door Embodiment of the invention. FIG. 46 is a simplified, scaled down, visual version of the design showing the four horizontal security bar assembly but also in this figure the 6 Sliding Door and Sliding Screen Guide Rail is a shortened version than previously submitted. In this case the Guide Rail only extends a portion of the way across the top and bottom of the 26 Frame. This allows for perhaps a lower installation cost but also allows for several design modifications that may suite various garage door manufactures designs. Because of this design change it may be necessary for the addition of a 32 Sliding Door and Screen Rail Brace, as shown here. Though not shown here in this figure, all other structural parts and options shown on previous figures will be incorporated in this figures design. By having the bars extend from one side of the panel to the other, the panel is strengthened and at the same time, security is increased. It is much less likely that a pet will escape or a burglar will enter the garage with the bars in place. FIG. 46 is an interior view of the “Pet View” option showing a four horizontal security bar assembly, versus six as shown in several previous figures, but this figure is also illustrating one of several other options for the mounting portion of the 13 Security Bar Assembly and the 32 Door and Screen Guide Brace to the 2 Garage Door Panel. The mounting portion of the Security Bars or Guide Brace may differ in shape and/or size depending upon the garage door panel construction and may not be limited to the designs show in any Figure. In this figure both are attached to the top and bottom portions of the garage door panel and are attached with a common washer, bolt, and nut assembly. It is typical, but not necessarily, depending on the garage door manufactures design, that the interior of the garage door has an interior “upper lip” and “lower lip” that runs the length of the garage door panel which allows for easy attachment of the security bars. This “upper and lower lip” manufactures' construction design makes the garage door panel more of a 3-D or “box type” configuration versus just a simple flat panel. This type of “lip” construction also allows for each individual garage door panel to abut one another and form a secure seal when closed and adds strength and stability to the garage door itself. It is also noted that most typical garage door also have this “lip” construction on each side of the garage door panels. It is also noted here that none of the “lip” type construction, typical to garage doors, is shown in any Figure submitted but should be assumed that it is prevalent.

The attachment of the 13 Security Bars and the 13 Guide Rail Brace directly to the 2 Garage Door Panel not only allows for the addition of these items to the design concept but also adds the dimension of additional structural integrity and strength to the overall garage door itself and the stability and strength to the 6 Sliding Door and Screen Guide Rails. Though a classic washer, bolt, and nut assembly may be the easiest and most common type of attachment method other attachment methods such as screws, adhesive, solder, welds, clips, or a combination of these and/or other methods may be used. Also, as noted previously, depending upon the garage door manufacturers garage door design and dimensions all aspects of this design can be modified to meet these specific needs.

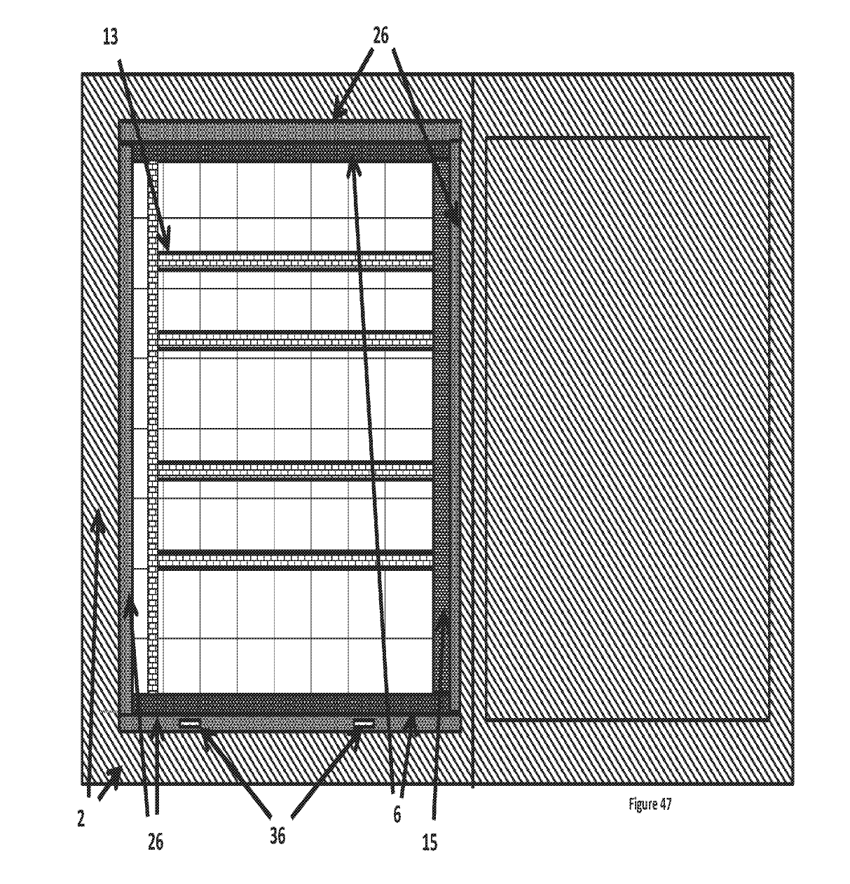

FIG. 47 is a front view of a garage door panel showing horizontal bars attached in a different manner in a Pet Door Embodiment of the invention. Though not shown here in this figure, all other structural parts and options shown on previous figures will be incorporated in this figures design. Because the bolt is attached on the “inside” of the panel, a potential burglar cannot unbolt it from the outside. FIG. 47 is another exterior view “Pet View Door” design. It is also shown here, not previously shown in any figure, is the addition of the 36 Weep Holes. Though referred to as a Weep “Hole” this opening may be a hole, slit, or other small opening in the Frame and may vary in its location in the frame. This “weep Hole” is an optional feature and may, or may not, be an addition to the exterior frame. This Weep Hole is used to prevent the buildup of moisture/water in the Frame and possible entry into the garage itself. It would probably, but not necessarily, be needed when the Frame is located at, or near, a bottom or lower garage door panel.

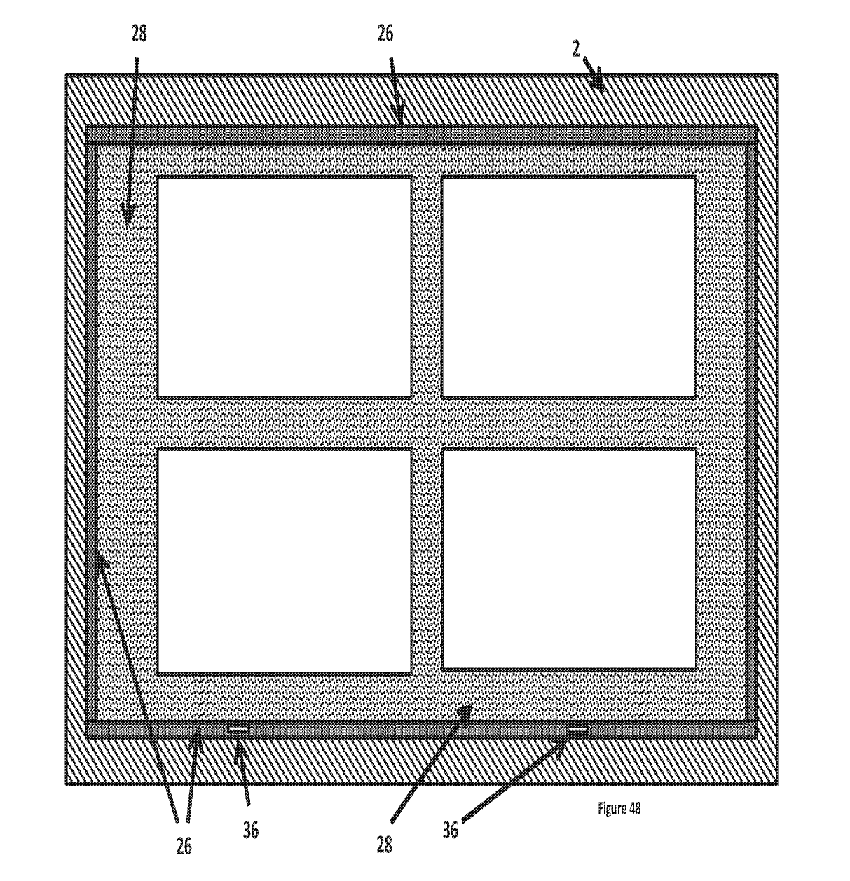

FIG. 48 is a front view of a garage door panel showing a Ventilation Window Concept with a front window cover. FIG. 48 is another exterior view of the sliding “Ventilation Window” design with one possible decorative window cover choice.

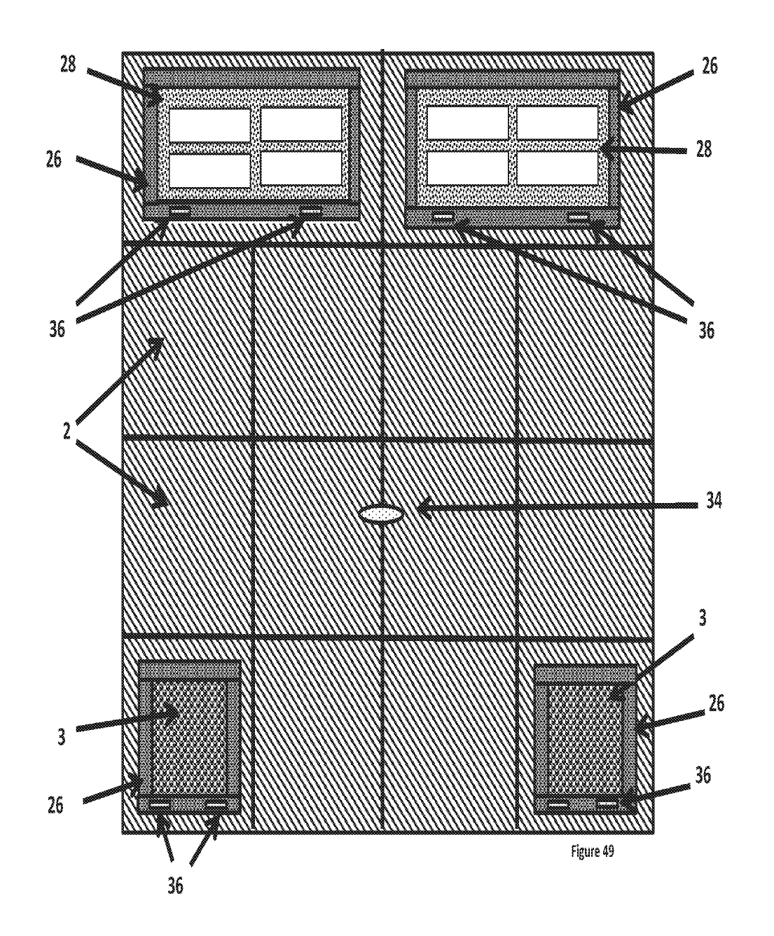

FIG. 49 is an exterior front view of one possible configuration of a garage door with upper sliding windows with the screen closed and lower sliding doors also with screen closed. This also shows possible locations of the 36 Weep Holes.

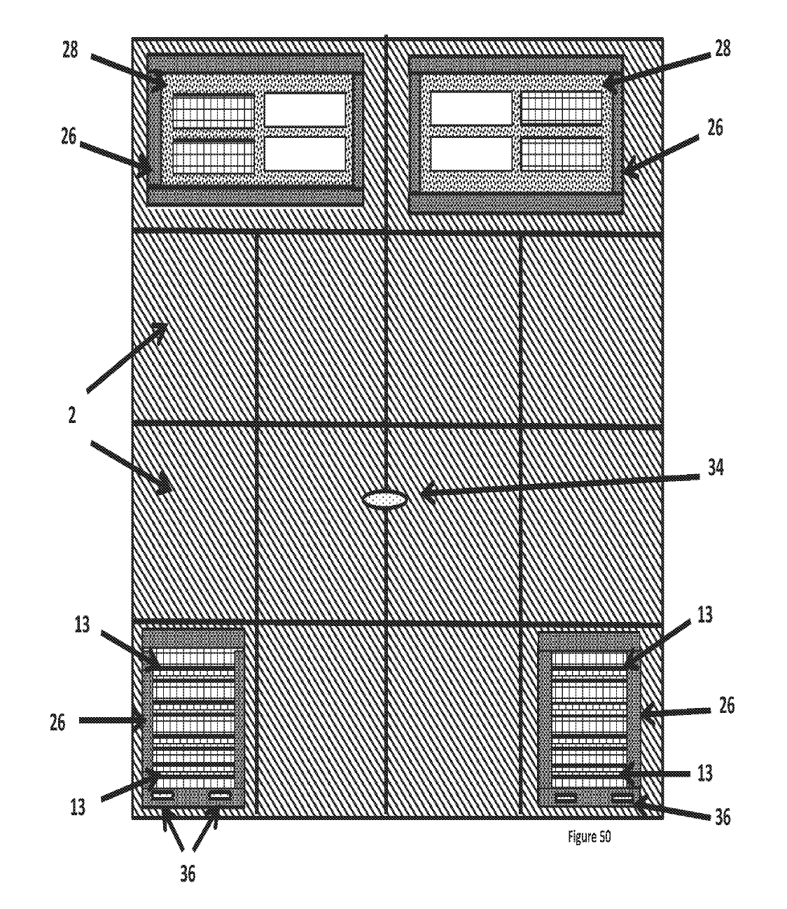

FIG. 50 is similar to FIG. 49 but shows what the concept might look like with the sliding screens in open positions. Also shown here is one possible option of no 36 Weep Holes present in the upper “Ventilation Windows” frames.

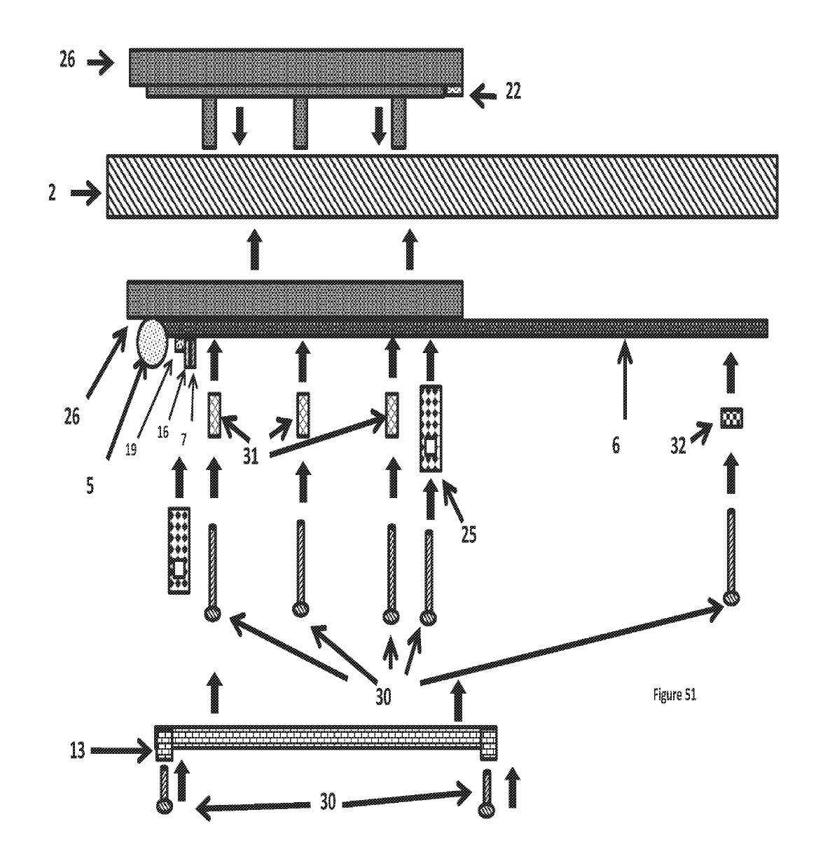

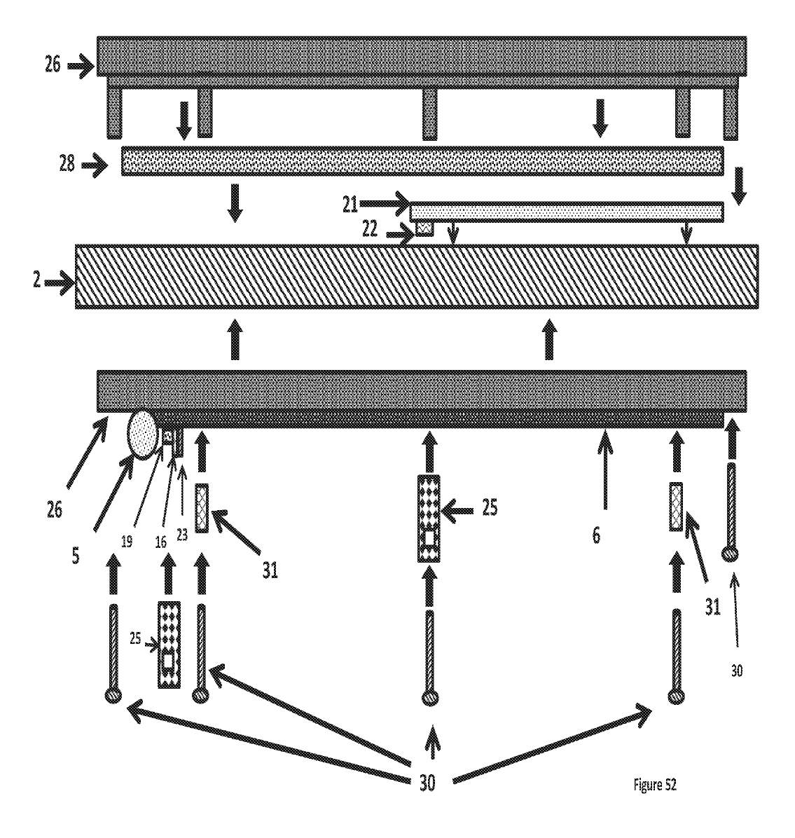

FIG. 51 is a top, exploded view of the Sliding “Pet View” Door concept, with Security Bars, with bolt or screw attachments and the parts relative placement to one another. It is noted that the parts are not to scale. It is also noted that here that a second 19 Locking Hasp is shown. Though not shown in any other figures, except for FIG. 52, this second Hasp would be attached to the frame and used to secure the sliding window or sliding door when they are in a closed position. Depending upon the location of the concept and level of placement on the garage door and garage door panel this second Hasp may be optional. It is noted that a second Locking Pin assembly may be used when a Locking Pin is used in place of a Hasp assembly. This second Locking Pin would serve the same purpose as a second Locking Hasp.

FIG. 52 is a top, exploded view of an embodiment that illustrates the top view of the sliding “Ventilation Window” concept.

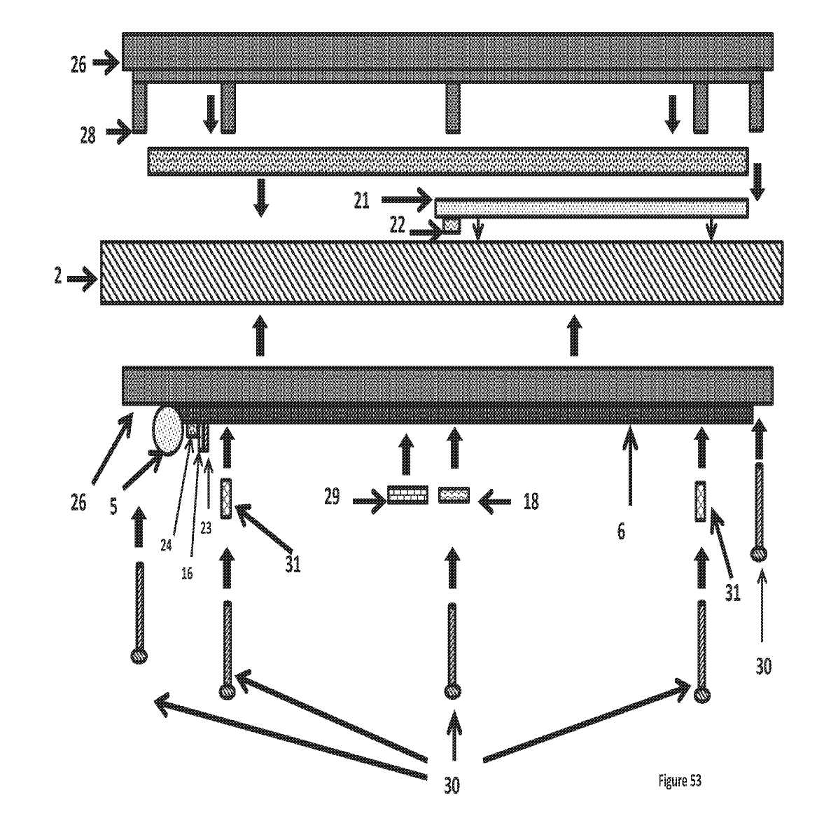

FIG. 53 is a top, exploded view of an embodiment that a top view with a Locking Pin/Pin Latch versus a Locking Hasp assembly. This figure also shows the optional magnet. FIG. 53 is similar to FIG. 52 but illustrates a top view with a Locking Pin/Pin Latch versus a Locking Hasp assembly

It is noted that FIGS. 51-53 show most parts needed to complete either the “Pet View” door or the “Ventilation Window” concept and their relative relationship to each other. However, depending upon the manufacturers design and the size of the potential opening cut into the garage door itself the exclusion and/or inclusion of some parts and/or the placement of certain parts, relative to each other, may vary. It is also noted that most of the parts shown can be preassembled so that either the “Pet View” door or the “Ventilation Window” concept would be one compact completely assembled unit.

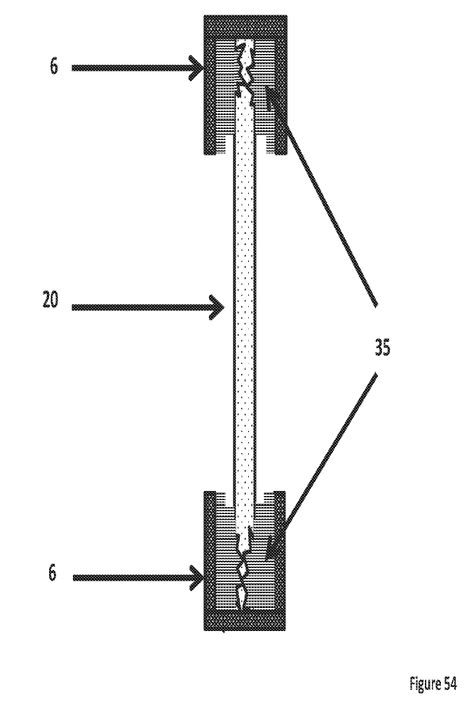

FIG. 54 is a side view of the sliding Guide Rails with “bushing” inserts. FIG. 54 is a side view of the sliding Guide Rails with “bushing” inserts. Though not shown in any previous Figures these inserts would be installed in all guide rails in all design concepts. These “bushings” can be made of various materials but generally would be of a “brush” type material. These “bushings” would help facilitate a more snuggly fitting of the window, door, or screen as they slide back and forth along the rails but these inserts would also act as an insulating material against wind, rain, or other exterior materials from entering the garage through a gap that might otherwise be present.

FIG. 55 is one potential side view of the sliding “Ventilation Window”/Screen Guide Rail and Frame assembly with bolt and/or screw attachment. This Figure is also similar to FIG. 45 but this Figure is much more detailed and inclusive of one potential design configuration. As previously noted, most parts can be preassembled so that all parts on the interior of the garage unit would be a preassembled unit attached directly to the interior frame and would only need to be attached to the exterior parts (exterior frame, stationary window, and optional window cover) by several screw or washers, nuts, and bolts placed through the interior frame and secured to the exterior frame and tightened snugly against the garage door itself.

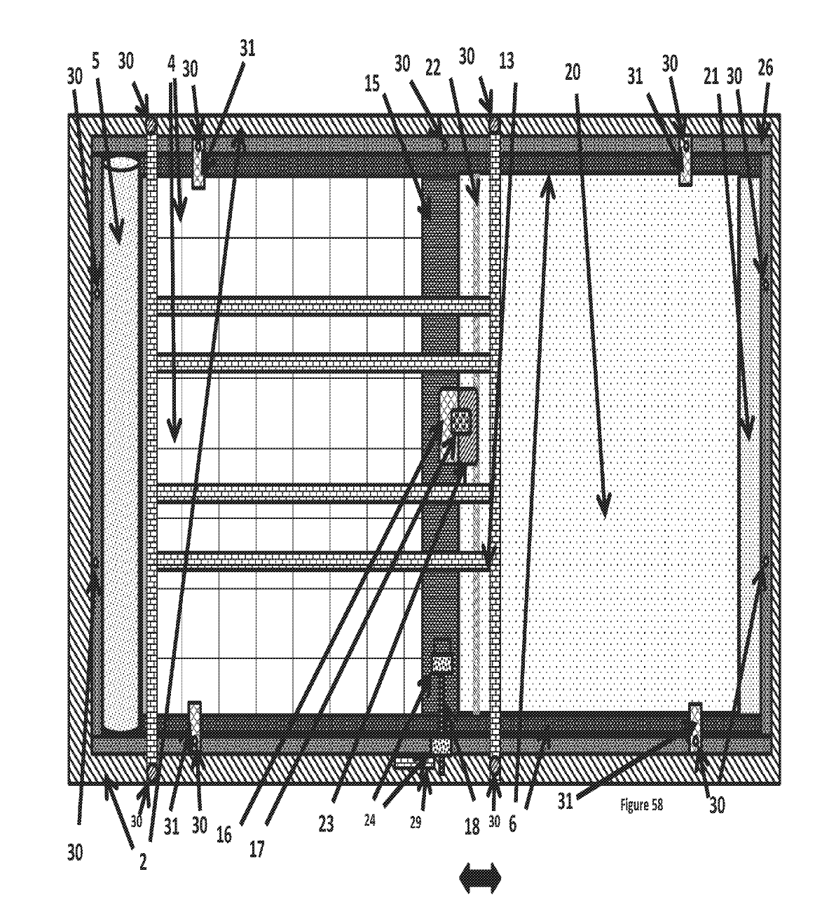

It is noted that FIG. 55 only shows the exterior frame “extensions”, previously mentioned with FIG. 45, near the top and bottom portion of the exterior frame. There would, however, be additional exterior frame “extensions” for the side portion of the “Ventilation Window” concept frame (see FIGS. 58, 59, and 62 with the additional 30 side frame screws).

FIG. 56 is side view that shows a side view of a Sliding “Pet View” Door/Screen Guide Rail and Frame assembly. In this case no front window or front window cover would be included. It is also noted, but not shown, that the exterior frames may be of slightly varying construction style due to the nature of the interior frame differences and/or size of the openings in the garage door panel. This embodiment differs from the embodiment of FIG. 44, as FIG. 44 shows bolt fasteners were put in from front of garage door, while FIG. 56 shows bolts from the interior side.

FIGS. 55 and 56 also show the additional bolt and nut attachment, of the interior 26 Frame directly to the 6 Guide Rail. Though this attachment is not necessary and may or may not be used in all concepts, depending upon the manufactures' garage door itself and/or other factors, it does lend to the concept of being able to be “preassembled”. In addition, this means of direct attachment may allow for the exclusion, or reduction in number, of the 31 Clip Fasteners that might otherwise be needed.

It is noted that the FIGS. 55 and 56 show that when all the parts are preassembled they can be installed by the garage door manufacturer at, or prior to, the point of sale of the garage door itself but also can be sold as an aftermarket unit, particularly in the case of the “Ventilation Window” concept that can easily installed by a consumer using the precut opening that had already been cut into the garage door panel by removing the already, manufacturer, installed window and installing the “Ventilation Window” unit in its place.

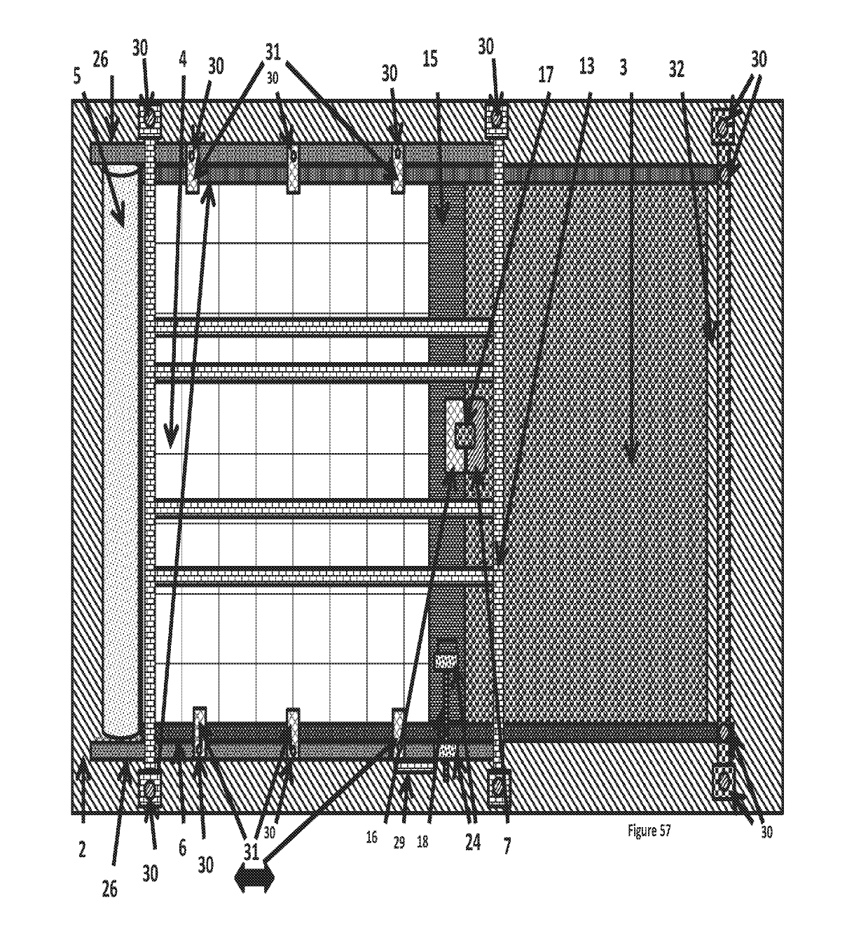

FIG. 57 is similar to several previous figures but this figure shows a “Pet View” door assembly with the Locking Pin/Pin Latch and optional Magnet being located near the bottom of the assembly verses the top.

FIG. 58 is a back view that shows the “Ventilation Window” assembly with the Locking Pin/Pin Latch, and optional Magnet being located near the bottom of the assembly verses the top. FIG. 58 is similar to previous figures but this figure shows the “Ventilation Window” assembly with the Locking Pin/Pin Latch, and optional Magnet being located near the bottom of the assembly verses the top. This Figure also shows a very slight variation of Security Bar construction style and attachment to the interior garage door panel (see FIG. 57 Security Bar construction for reference). FIG. 58 also shows the possible placement of the 30 securing screws through the 31 Securing Clips, thus attaching the clips directly onto the interior frame. Also shown is the placement of additional 30 Screws in the side portions of the 26-interior frame. These 30 Screws Fasteners would go through the interior frame and be secured into the exterior frame's “extensions” as previously discussed. It is noted that the number, and exact placement location, of these screw, or bolt fasteners, may vary depending upon the size of the manufacturers' garage door and/or size of the 26 Frame and/or the number of 31 Clip Fasteners used and/or the number of screws/bolts needed for proper installation/operation and/or attachment of the interior frame to the exterior frame, of either concept.

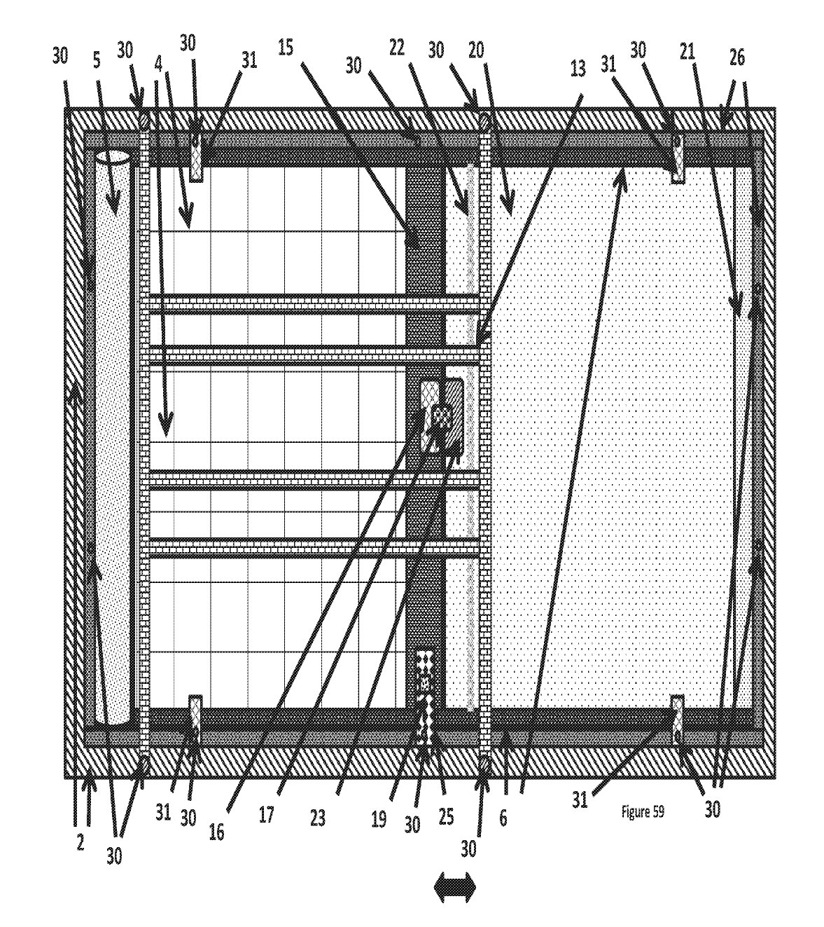

FIG. 59 is similar to FIG. 58 but this Figure shows a Locking Hasp/Hasp Latch located near the bottom of the assembly and instead of a Locking Pin/Pin Latch.

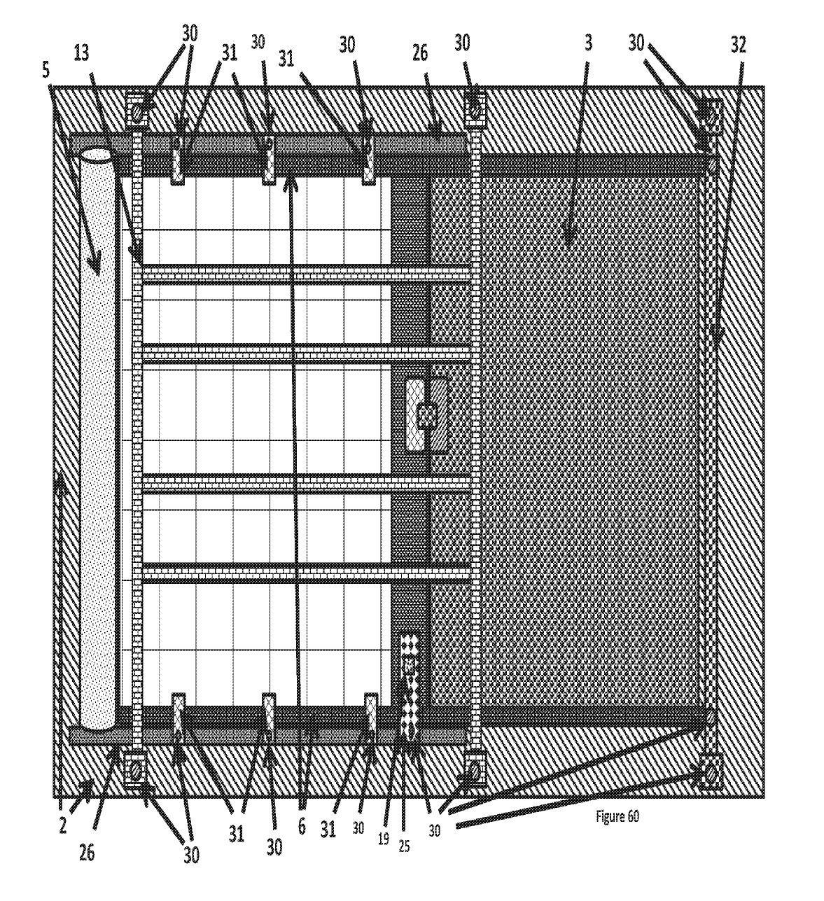

FIG. 60 is similar to FIG. 57 but this figure shows a Locking Hasp/Hasp Latch located near the bottom of the assembly and instead of a Locking Pin/Pin Latch.

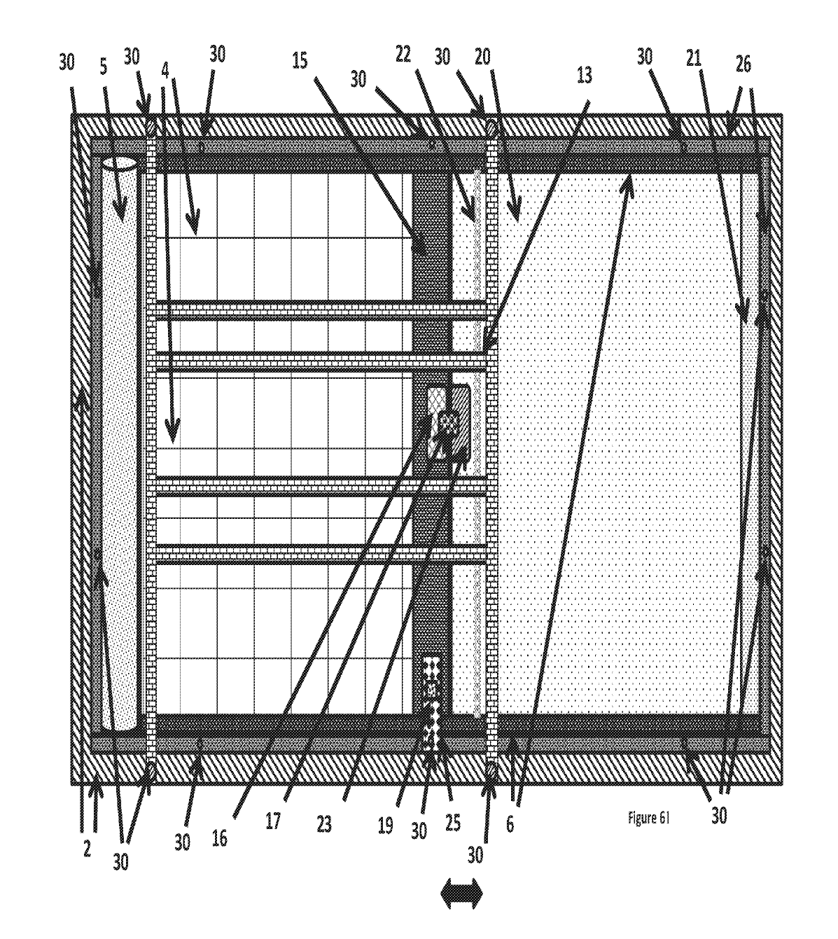

FIG. 61 is similar to FIG. 59 but in this figure no Clip Fasteners are used. It is noted, as previously stated, that the number of Clip Fasteners used, in any concept, may vary depending upon the need for proper stability and/or operation and/or method of attachment of the Frame to the Guide Rails.

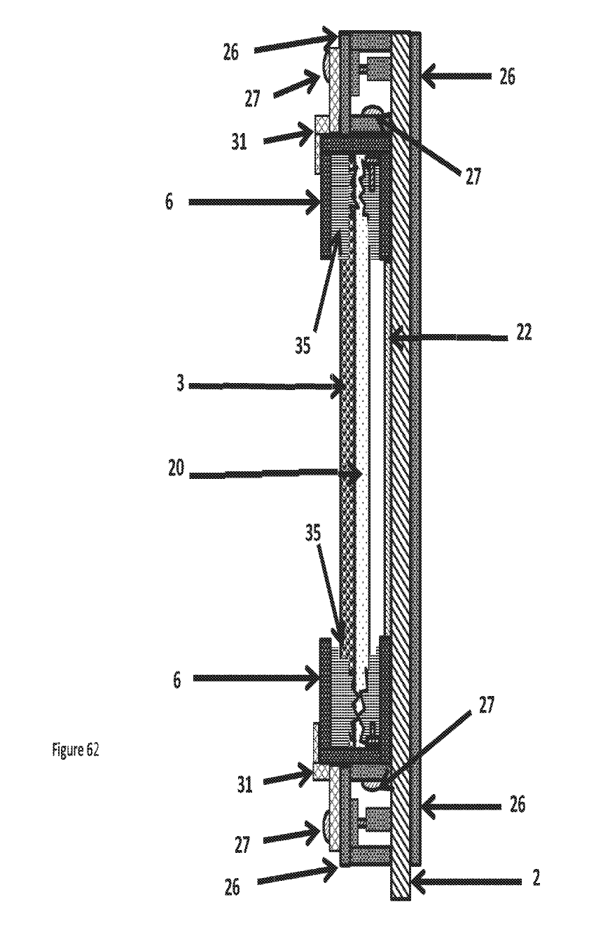

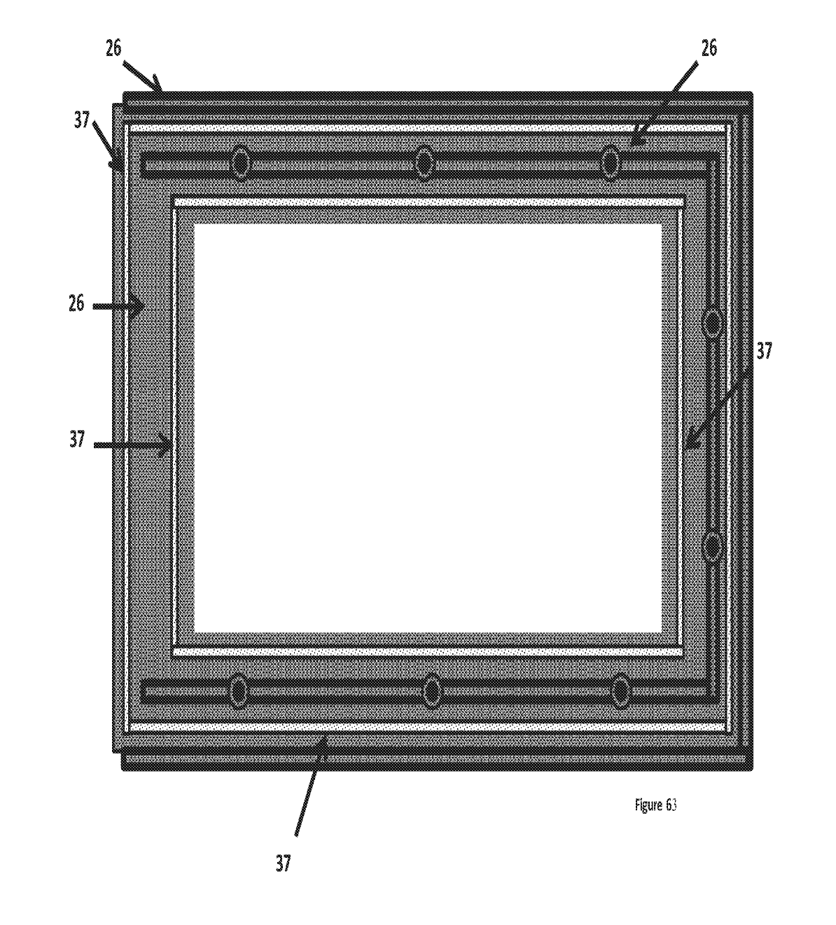

FIG. 62 is a side view that shows the addition of an optional Sliding Window. In this variation of the “Pet View” door concept a clear sliding window would take the place of the solid sliding door that has been featured in all previous figures of the “Pet View” door concept, with an added secondary sliding door in addition to the sliding window. FIG. 63 is similar to FIG. 56 but in this figure, it shows the addition of an optional Sliding Window. In this variation of the “Pet View” door concept a clear sliding window would take the place of the solid sliding door that has been featured in all previous figures of the “Pet View” door concept. This sliding clear window would be attached to the sliding screen. A secondary sliding solid door would be placed directly behind the clear window. This secondary sliding door would have its own handle attached but would not be attached to any other part of the assembly. It would slide independently along the guide rails. This option of the “Pet View” door would allow consumers a choice that would give their pets the option of sitting in the garage and have the ability to look out of the garage but still have the sliding screen in a closed position. The secondary sliding solid door would serve as a cover to the sliding window and when the sliding solid cover is closed would prevent the viewing of the interior of the garage from an outside perspective.

FIG. 63 is an illustration of one potential construction design for the exterior 26 Frame for the “Ventilation Window” concept. This is an interior view of the exterior frame. This shows the addition of a 37 “Secondary Insulation”. It would differ from the 22 Insulation Strip in that this Secondary Insulation would be more of a foam type substance verses a “brush” type insulation. It would be applied to the interior portion of the frame and act as a sealant between the exterior frame and the interior frame when they are tightened together. This figure also shows the (round) frame “extensions” that the 30 Screw Fasteners would be screwed into. In this figure only 3 sides show these frame “extensions”. The omitting of the fourth side of extensions would permit for the placement of the 5 Screen Roller onto the interior frame. Thus, no screws would be used to secure the interior frame to the exterior frame on the side of the Screen Roller. It is noted, however, that depending upon the size and/or shape of the manufacturers' window opening the fourth side (in this figure it would be the left side of the frame) may also have these screw holes constructed into the frame, if the size of the panel would permit proper placement of the Screen Roller.

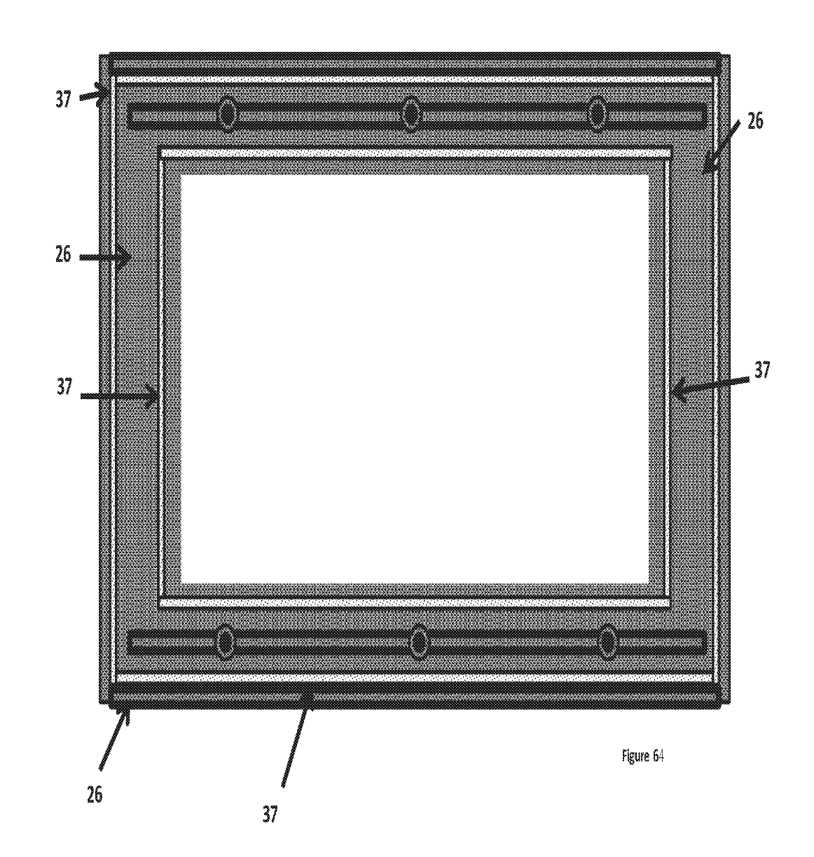

FIG. 64 is similar to FIG. 64 but this figure shows the interior view of the exterior frame for the “Pet View” door concept. It shows a slightly different variation in the frames construction in that it only has the screw “extensions” on the upper and lower portion of the frame. It is presumed, but not necessarily, that the “Pet View” door concept would have a smaller opening in the garage door panel than the “Ventilation Window” concept (refer back to FIGS. 49-50). The omitting of the fourth side of the frame “extensions” would allow for the sliding of the door along the Guide Rails.

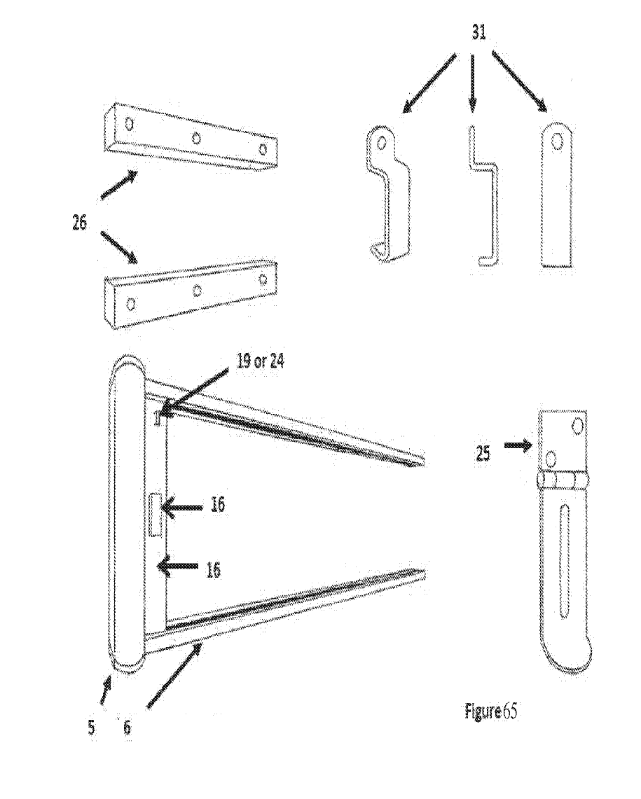

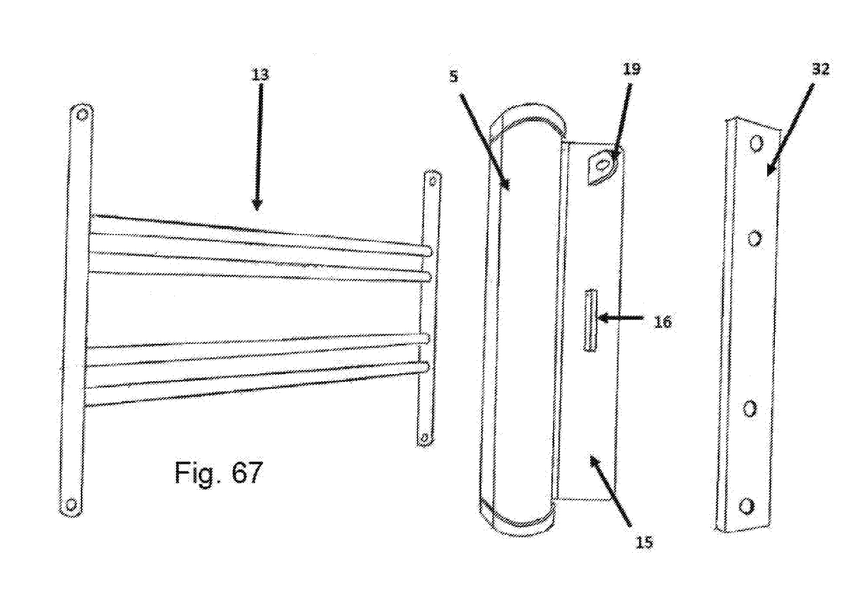

FIGS. 65-67 are renditions of various parts shown in previous figures for the “Pet View” concept. They are only one possible construction design of the various parts shown and may or may not be the final construction design of the part eventually used for the needed concept. FIG. 67 is a rendition of the “Pet View” concept. These 3 figures are presented only as a means to present a different, more of a 3-D view, of the concepts presented. Parts are not drawn to scale.

FIG. 65 is an exploded view of the “Pet View” concept.

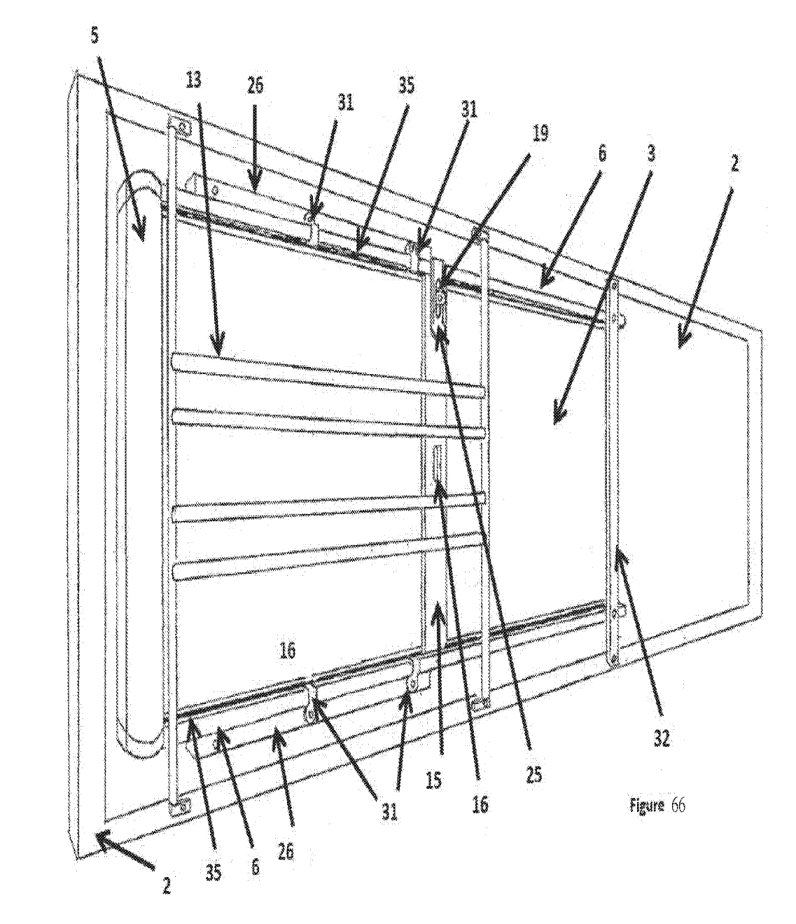

FIG. 66 is a back, perspective view of a potential “Pet View” door concept.

FIG. 67 is a perspective view of various parts shown in previous figures for the “Pet View” concept.

Summary of various embodiments of the invention. This invention, the Ventilation & Pet View Garage Door Panel, is a newly adapted garage panel that can easily be installed in most common garage doors. Not only is it available for any new garage door replacement but can also be installed as a panel in most existing garage doors by merely replacing any individual panel and can be made from of a variety of materials such as wood or metal. The functions of this invention are to allow proper ventilation of the garage, allowing fresh air and light in making for a fresher and brighter garage while offering total security. Also, for the pet lovers in the world, which has always been a major influence in any society, allows the pet owner an easy and safe way to house their pets giving access for their pets to an additional area of living space without the need for total outside access. Many pet owners lock their pet family members in the garage. This invention allows for much more light and better ventilation and a much more open, less stressful area, giving their pets an additional feeling of an open, natural outside environment and still offering complete security from outside entrance. Unlike some other, already on the market, garage ventilation systems this particular invention does not need any additional hardware to be purchased, any large expensive swinging gates or grates, can be easily slid opened to varying positions permitting numerous options for the home owner's desired needs for ventilation, light, and air flow and/or outside pet viewing access. Most, already on the market products, only allow a complete open or closed position. Also, when closed this has the appearance as a normal garage door. It is an easy installation with easy access to the product, multiple purpose, simple functionality with a simple slide of the cover, all with complete garage security.

The invention is a modified garage door panel with a built-in ventilation and/or pet view door. The pet view door would be most effective located as the bottom panel of any garage door for any one, two, or multiple car garage. However, the panel itself can be located at any level within the garage door and can be installed as one or more panels of the garage door offering several ventilation and pet viewing options. The door within the panel itself can also be located at center, right, or left and can consist of one, two, or more doors per panel though optimal usage would be for a minimum of two doors per panel. The 2 Ventilation and Pet View Garage Door Panel would consist of a square or rectangular opening that would have a 3 Sliding door that can be moved right to left and left to right along the 6 Sliding Door and Sliding Screen Guide Rail. When closed the 3 Sliding door would secure tightly in the opening of the pet door by 8 Sliding Door Securing Braces fitted into the 10 Sliding Door Securing Brackets. There would also be a slight overlap of the 3 Sliding door that would fit snugly against the inside of the garage door panel prohibiting the 3 Sliding Door from being pushed out through the front of the opening. The 10 Sliding Door Securing Brackets would be located between the 2 Garage Door Panel and the 5 Spring Activated Screen Roller. The 10 Sliding Door Securing Brackets would be attached to the back of the 2 Ventilation and Pet View Garage Door Panel and would have a slightly raised configuration to allow the 8 Sliding Door Securing Braces to slide into and secure the door. When closed the 2 Ventilation and Pet View Garage Door Panel would give the frontal street appearance of a 1 Regular Garage Door Panel. The 3 Sliding door would also have a 7 Sliding Door Handle attached to the inside of the sliding cover to help facilitate the opening and closing of the cover. Also attached to the inside of the 3 Sliding door, mounted on top of the 8 Sliding Door Securing Brace would be a 9 Sliding Door Securing Brace Screen Hook. This hook would secure the 11 Adjustable/Removable Securing Screen Hook. The 11 Adjustable/Removable Securing Screen Hook would be attached to the 4 Sliding Screen. When the 11 Screen Securing Hooks are attached to the 9 Sliding Door Securing Brace Screen Hook the 4 Sliding Screen would move right to left and left to right, along the 6 Sliding Door and Sliding Screen Guide Rails, in unison with the 3 Sliding door and when in the open position would cover the open space in the garage door panel allowing ventilation and outside viewing for pets but hindering debris from being blown into the garage. When the 4 Sliding Screen is moved left to right or right to left it uncoils and/or recoils around the 5 Spring Activated Screen Roller. When in the closed position the 4 Sliding Screen would allow the 3 Sliding door to snugly fit in the closed position. Depending upon the configuration and location of the 2 Ventilation and Pet View Garage Door panel openings the 5 Spring Activated Screen Roller would be located to either the right or left side of the door opening and the 3 Sliding door would be located to the opposite side of the 2 Ventilation and Pet View Garage Door Panel. The 11 Adjustable/Removable Screen Securing Hooks can also be lifted and unsecured from the 9 Sliding Door Securing Brace Screen Hooks thus allowing the 3 Sliding Door to be moved left to right or right to left while allowing the 4 Sliding Screen to remain coiled around the 5 Spring Activated Screen Roller. This allows the user the choice as to have the opening screen covered or not. The 11 Screen Securing Hooks would remain attached to the 4 Sliding Screen and can be reattached/unattached at any time to the 9 Sliding Door Securing Brace Screen Hooks. The 4 Sliding Screen and 5 Spring Activated Screen Roller can be an option to be purchased and included by the end user. Regardless as to whether the 4 Sliding Screen and 5 Spring Activated Screen Roller is part of the assembly the remainder of the 2 Ventilation and Pet View Garage Door Panel would continue to be operable in all other capacities it is designed for. The 3 Sliding door, and when attached, the 4 Sliding Screen can be moved left to right or right to left along the 6 Guide Rail to varying degrees of openness allowing the user to choose a fully open, closed, or partially opened position. The 2 Ventilation and Pet View Garage Door Panel would also have attached either 12 Vertical Security Bars or 13 Horizontal Security Bars. The 12 Vertical Security Bars or the 13 Horizontal Security Bars would be directly secured and attached to an extended portion of the garage door panel. The 12 or 13 Security Bars would be attached in a manner allowing the 3 Sliding door and/or 4 Sliding Screen to be moved freely left to right or right to left behind the bars. The 12 or 13 Security Bars would remain in a fixed position at all times lending to a safe and secure garage when the 3 Sliding door is in an open position. Also, as an option could be the installation of air circulating fans to the right or left of the Ventilation Door opening.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### GARAGE DOOR PANEL ITEM NUMBERS

1 Garage Door Panel
2 Garage Door Panel with Ventilation and Pet View Door
3 Sliding Door
4 Sliding Screen
5 Spring Activated Screen Roller
6 Sliding Door and Sliding Screen Guide Rail
7 Sliding Door Handle
8 Sliding Door Securing Brace
9 Sliding Door Securing Brace Screen Hooks
10 Sliding Door Securing Brackets
11 Adjustable/Removable Securing Screen Hooks
12 Vertical Security Bars
13 Horizontal Security Bars
14 Air Circulating Fan
15 Screen Roller Screen Support Bar
16 Screen Roller Screen Support Bar Handle
17 Handle Securing Clip
18 Locking Pin
19 Locking Hasp Latch
20 Clear Sliding Window
21 Clear Stationary Window
22 Insulation Strip
23 Sliding Window Handle
24 Locking Pin Latch
25 Locking Hasp
26 Frame
27 Fastener
28 Decorative Window or Front Cover
29 Magnet
30 Bolt or Screw Frame Fastener
31 Clip Fastener
32 Sliding Door and Sliding Screen Rail Brace
33 Washer, Bolt and Nut Assembly
34 Garage Door Handle
35 Bushing
36 Weep Hole
37 Secondary Insulation

That which is claimed:

1. A window for a garage door panel, comprising: a body, an opening, and means to attach the body to a panel of a garage door, where the opening is located in the body, and bounded on all sides by the body, additionally comprising a stationary panel and a sliding panel, where the stationary panel and the sliding panel are contained within the opening, additionally comprising a screen guide rail, where the sliding panel slides within the screen guide rail, where the sliding panel can be moved in a lateral direction across the body, additionally comprising a sliding door handle, where the sliding door handle is attached to the sliding door panel and allows a user to slide the sliding panel by applying a pressure to the sliding door handle, two sliding door securing braces and two sliding door securing brace screen hooks, where each of the two sliding door securing brace hooks is located on a front face of each of the sliding door securing braces, where the two sliding door securing brackets mate with the two sliding door securing brace hooks such that a user can securely close the sliding door across the opening.

2. The window of claim 1, additionally comprising a sliding screen where the sliding screen is capable of being rolled out to completely cover the opening, additionally comprising a spring-activated screen roller, where the spring-activated screen roller is attached to the sliding screen, where the spring-activated screen roller can retract the sliding screen upon an activation of the spring-activated screen roller.

3. The window of claim 2, additionally comprising one or more air-circulating fans, an insulation strip, one or more clip fasteners, where the one or more clip fasteners removably secure the body to the panel, one or more locking hasps, a sliding door and sliding screen rail brace,

4. The window of claim 2, where the opening additionally comprises one or more security bars.

5. The window of claim 4, additionally comprising one or more bolt frame fasteners, where the one or more bolt frame fasteners attach the one or more security bars to the body.

6. The window of claim 5, where the one or more security bars are aligned in a vertical position.

7. The window of claim 5, where the one or more security bars are aligned in a horizontal position.

8. The window of claim 2, where the means to attach to body to the panel is one or more bolts, where the one or more bolts are inserted through one or more bolt holes, with a bolt head located outside the panel and a nut located inside the panel, where one or more bolt hole threads mate with one or more nut threads to secure the body to the panel.

9. The window of claim 2, where the means to attach to body to the panel is one or more screws, where the one or more screws are inserted through the body into the panel, from an inside of the panel, to secure the body to the panel.

10. The window of claim 2, additionally comprising at least one screen roller screen support bar and at least one screen roller screen support bar handle, and at least one handle securing clip, where the screen can be secured with a locking pin and locking pin latch.

11. The window of claim 2, additionally comprising at least one screen roller screen support bar and at least one screen roller screen support bar handle, and at least one handle securing clip, where the screen can be secured with a locking hasp latch and locking hasp.

12. The window of claim 2, additionally comprising one or more bushings, where the one or more bushings are located in the screen rail guide, and, additionally comprising at least one frame, where the frame is an interior frame, and located on an interior portion of the body, and where the interior frame secures at least one guide rail.

13. The window of claim 2, additionally comprising one or more weep holes.

14. A window for a garage door panel, comprising: a body, an opening, and means to attach the body to a panel of a garage door, where the opening is located in the body, and bounded on all sides by the body, additionally comprising a sliding window, where the sliding window can be moved in a lateral direction across the body to cover and uncover the opening, where the opening additionally comprises one or more security bars, additionally comprising one or more clip fasteners, where the one or more clip fasteners removably secure the body to the guide rail.

15. The window of claim 14, additionally comprising a sliding screen where the sliding screen is capable of being rolled out to completely cover the opening, additionally comprising a spring-activated screen roller, where the spring-activated screen roller is attached to the sliding screen, where the spring-activated screen roller can retract the sliding screen upon an activation of the spring-activated screen roller, where the means to attach to body to the panel is one or more bolts, where the one or more bolts are inserted through one or more bolt holes, with a bolt head located outside the panel and a nut located inside the panel, where one or more bolt hole threads mate with one or more nut threads to secure the body to the panel.

16. The window of claim 15, additionally comprising one or more bushings, where the one or more bushings are located in the screen rail guide, and, additionally comprising one or more bolt frame fasteners, where the one or more bolt frame fasteners attach the one or more security bars to the body.

17. The window of claim 16, where the one or more security bars are aligned in a horizontal position, and, additionally comprising at least one frame, where the frame is an interior frame, and located on an interior portion of the body, and where the interior frame secures at least one sliding panel.

18. A garage door panel window, comprising: a body, means of ventilation, an opening, and means to attach the body to a panel of a garage door, where the opening is located in the body, and bounded on all sides by the body, where the opening additionally comprises one or more security bars.

19. The garage door panel window of claim 18, additionally comprising a stationary panel and a sliding panel, where the stationary panel and the sliding panel are contained within the opening, additionally comprising a screen guide rail, where the sliding panel slides within the screen guide rail, where the sliding panel can be moved in a lateral direction across the body, additionally comprising a sliding door handle, where the sliding door handle is attached to the sliding door panel and allows a user to slide the sliding panel by applying a pressure to the sliding door handle, two sliding door securing braces and two sliding door securing brace screen hooks, where each of the two sliding door securing brace hooks is located on a front face of each of the sliding door securing braces, where the two sliding door securing brackets mate with the two sliding door securing brace hooks such that a user can securely close the sliding door across the opening.

20. The garage door panel window of claim 18, where the opening additionally comprises one or more security bars, where the means to attach to body to the panel is one or more bolts, where the one or more bolts are inserted through one or more bolt holes, with a bolt head located outside the panel and a nut located inside the panel, where one or more bolt hole threads mate with one or more nut threads to secure the body to the panel, additionally comprising at least one screen roller screen support bar and at least one screen roller screen support bar handle, and at least one handle securing clip, where the screen can be secured with a locking hasp latch.
